(19) United States
(12) Patent Application Publication
(10) Pub. No.: US 2025/0214802 A1
(43) Pub. Date: Jul. 3, 2025

(54) SHEET PROCESSING APPARATUS, SHEET ACCOMMODATING APPARATUS, AND IMAGE FORMING SYSTEM

(71) Applicant: CANON FINETECH NISCA INC., Saitama (JP)

(72) Inventors: Akito Yoda, Yamanashi (JP); Shinnosuke Enomoto, Yamanashi (JP); Shoubu Kato, Yamanashi (JP); Satoshi Horiguchi, Yamanashi (JP); Hiroki Komada, Yamanashi (JP); Taiki Akiyama, Chiba (JP)

(21) Appl. No.: 18/981,939

(22) Filed: Dec. 16, 2024

(30) Foreign Application Priority Data
Dec. 28, 2023 (JP) 2023-222471
Oct. 16, 2024 (JP) 2024-180650

(51) Int. Cl. B65H 45/30; B42C 1/12; G03G 15/00

(52) U.S. Cl. CPC B65H 45/30; B42C 1/12; G03G 15/6544; B65H 2301/51232; B65H 2402/32; B65H 2402/60; B65H 2403/60; B65H 2701/13212; G03G 2215/00936

(57) ABSTRACT

A sheet processing apparatus includes a processing unit, a braking mechanism, and, a damper mechanism. The processing unit is movable to a drawn-out position and an accommodated position. The drawn-out position is a position where the processing unit is drawn out from the sheet processing apparatus. The accommodated position is a position where the processing unit is accommodated in the sheet processing apparatus. The braking mechanism acts to brake the processing unit in a case where the processing unit is inserted in a direction from the drawn-out position toward the accommodated position at a speed equal to or higher than a predetermined speed. The damper mechanism absorbs an impact on the braking mechanism in a case where the braking mechanism act, by applying a load to the processing unit moving in the direction from the drawn-out position toward the accommodated position.

### BACKGROUND OF THE INVENTION

### Field of the Invention

The present invention relates to a sheet processing apparatus that performs a predetermined process on a sheet, a sheet accommodating apparatus that accommodates a sheet, an image forming system including the sheet processing apparatus, and an image forming system including the sheet accommodating apparatus.

### Description of the Related Art

Conventionally, a sheet processing apparatus includes a processing unit that performs various processes such as a binding process on a sheet. In addition, examples of the configuration of the sheet processing apparatus include a configuration in which the processing unit is configured to be capable of being drawn out from the casing of the apparatus for a replacement work of a replaceable part of the processing unit or jam removal of a sheet. In addition, examples of the configuration of a sheet accommodation apparatus that accommodates a sheet also include a configuration in which an accommodation unit that accommodates the sheet is configured to be capable of being drawn out from the casing of the apparatus for jam removal or for replenishing the accommodation unit with sheets.

Here, in the case of a configuration including a draw-out unit capable of being drawn out such as a processing unit of a sheet processing apparatus or an accommodation unit of a sheet accommodating apparatus, there is a case where the draw-out unit is inserted at a high speed when inserting the draw-out unit into the apparatus from a drawn-out state. In this case, there is a possibility that the draw-out unit having been inserted at a high speed collides with the frame of the apparatus or a part in the apparatus to cause a trouble such as malfunction or breakage.

Therefore, braking the draw-out unit in motion by using a braking device as described in Japanese Utility Model Application Laid-Open No. S60-118033 can be considered. According to the braking device as described in Japanese Utility Model Application Laid-Open No. S60-118033, braking the draw-out unit in motion in the case where the draw-out unit is inserted at a high speed and thus suppressing a situation in which the draw-out unit collides with the frame of the apparatus or a part in the apparatus can be considered.

However, in the case of using the configuration of Japanese Utility Model Application Laid-Open No. S60-118033 as a braking mechanism of the draw-out unit, the movement of the draw-out unit is suddenly stopped when the draw-out unit inserted at a high speed is braked. At this time, particularly in the case where, for example, the draw-out unit is heavy, there is a possibility that a large load is applied to the braking mechanism as a result of the sudden stoppage of the movement of the draw-out unit and thus a trouble occurs in the braking mechanism.

### SUMMARY OF THE INVENTION

The present invention provides a configuration capable of suppressing occurrence of a trouble in a braking mechanism in a configuration in which a brake acts in the case where a unit capable of being drawn out such as a processing unit or an accommodation unit is inserted at a high speed.

According to a first aspect of the present invention, a sheet processing apparatus includes a processing unit movable to a drawn-out position and an accommodated position and configured to perform a predetermined process on a sheet, the drawn-out position being a position where the processing unit is drawn out from the sheet processing apparatus, the accommodated position being a position where the processing unit is accommodated in the sheet processing apparatus, a braking mechanism configured to act to brake the processing unit in a case where the processing unit is inserted in a direction from the drawn-out position toward the accommodated position at a speed equal to or higher than a predetermined speed, and, a damper mechanism configured to absorb an impact on the braking mechanism in a case where the braking mechanism act, by applying a load to the processing unit moving in the direction from the drawn-out position toward the accommodated position.

According to a second aspect of the present invention, an image forming system includes an image forming unit including an image forming portion configured to form an image on a sheet, and, a sheet processing apparatus configured to perform a predetermined process on the sheet on which the image has been formed by the image forming portion. The sheet processing apparatus includes a processing unit movable to a drawn-out position and an accommodated position and configured to perform the predetermined process on the sheet, the drawn-out position being a position where the processing unit is drawn out from the sheet processing apparatus, the accommodated position being a position where the processing unit is accommodated in the sheet processing apparatus, a braking mechanism configured to act to brake the processing unit in a case where the processing unit is inserted in a direction from the drawn-out position toward the accommodated position at a speed equal to or higher than a predetermined speed, and, a damper mechanism configured to absorb an impact on the braking mechanism in a case where the braking mechanism act, by applying a load to the processing unit moving in the direction from the drawn-out position toward the accommodated position.

According to a third aspect of the present invention, a sheet accommodating apparatus includes an accommodation unit movable to a drawn-out position and an accommodated position and configured to accommodate a sheet, the drawn-out position being a position where the accommodation unit is drawn out from the sheet accommodating apparatus, the accommodated position being a position where the accommodation unit is accommodated in the sheet accommodating apparatus, a braking mechanism configured to act to brake the accommodation unit in a case where the accommodation unit is inserted in a direction from the drawn-out position toward the accommodated position at a speed equal to or higher than a predetermined speed, and, a damper mechanism configured to absorb an impact on the braking mechanism in a case where the braking mechanism act, by applying a load to the accommodation unit moving in the direction from the drawn-out position toward the accommodated position.

According to a fourth aspect of the present invention, an image forming system includes a sheet accommodating apparatus configured to accommodate a sheet, and, an image forming unit including an image forming portion configured to form an image on the sheet fed from the sheet accommodating apparatus. The sheet accommodating apparatus includes an accommodation unit movable to a drawn-out position and an accommodated position and configured to accommodate the sheet, the drawn-out position being a position where the accommodation unit is drawn out from the sheet accommodating apparatus, the accommodated position being a position where the accommodation unit is accommodated in the sheet accommodating apparatus, a braking mechanism configured to act to brake the accommodation unit in a case where the accommodation unit is inserted in a direction from the drawn-out position toward the accommodated position at a speed equal to or higher than a predetermined speed, and, a damper mechanism configured to absorb an impact on the braking mechanism in a case where the braking mechanism act, by applying a load to the accommodation unit moving in the direction from the drawn-out position toward the accommodated position.

Further features of the present invention will become apparent from the following description of exemplary embodiments with reference to the attached drawings.

### BRIEF DESCRIPTION OF THE DRAWINGS

FIG. 1 is a schematic configurational section view of an image forming system according to an embodiment.

FIG. 2 is a schematic configurational section view of a sheet processing apparatus according to the embodiment.

FIG. 3 is a control block diagram of the image forming system according to the embodiment.

FIG. 4 is an enlarged section view of a saddle portion according to the embodiment.

FIG. 5 is a front view of a folding processing portion according to the embodiment.

FIG. 6A is a perspective view of a square back processing unit according to the embodiment.

FIG. 6B is a section view of the square back processing unit according to the embodiment.

FIG. 7A is a perspective view of an additional folding processing portion according to the embodiment as viewed from the front side.

FIG. 7B is a perspective view of the additional folding processing portion according to the embodiment as viewed from the rear side.

FIG. 8 is a perspective view of part of the square back processing unit and a driving portion according to the embodiment.

FIG. 9 is a perspective view of the vicinity of the square back processing unit and a clamp portion according to the embodiment.

FIG. 10 is a section view of the square back processing unit and the clamp portion according to the embodiment.

FIG. 11A is a schematic diagram illustrating a state in which conveyance of a sheet bundle is stopped by a clamp unit in an operation of a square back process in the embodiment.

FIG. 11B is a schematic diagram illustrating a state in which the sheet bundle is clamped in the operation of the square back process in the embodiment.

FIG. 11C is a schematic diagram illustrating a state in which the square back process is performed on the sheet bundle in the operation of the square back process in the embodiment.

FIG. 11D is a schematic diagram illustrating a state in which the clamping of the sheet bundle is released in the operation of the square back process in the embodiment.

FIG. 12A is a perspective view of the sheet processing apparatus according to the embodiment in a state in which a front cover is closed.

FIG. 12B is a perspective view of the sheet processing apparatus according to the embodiment in a state in which the front cover is open.

FIG. 13 is a perspective view of the sheet processing apparatus according to the embodiment in a state in which a saddle portion has been drawn out.

FIG. 14 is a perspective view of a braking mechanism according to the embodiment.

FIG. 15 is a partially-omitted perspective view of the braking mechanism according to the embodiment.

FIG. 16A is a plan view illustrating a state in which the brake of a centrifugal brake unit according to the embodiment is not acting.

FIG. 16B is a plan view illustrating a state in which the brake of the centrifugal brake unit according to the embodiment is acting.

FIG. 17A is a perspective view illustrating the state in which the brake of the centrifugal brake unit according to the embodiment is not acting.

FIG. 17B is a perspective view illustrating the state in which the brake of the centrifugal brake unit according to the embodiment is acting.

FIG. 18 is a front view of large-capacity cassettes according to another example of the embodiment.

### DESCRIPTION OF THE EMBODIMENTS

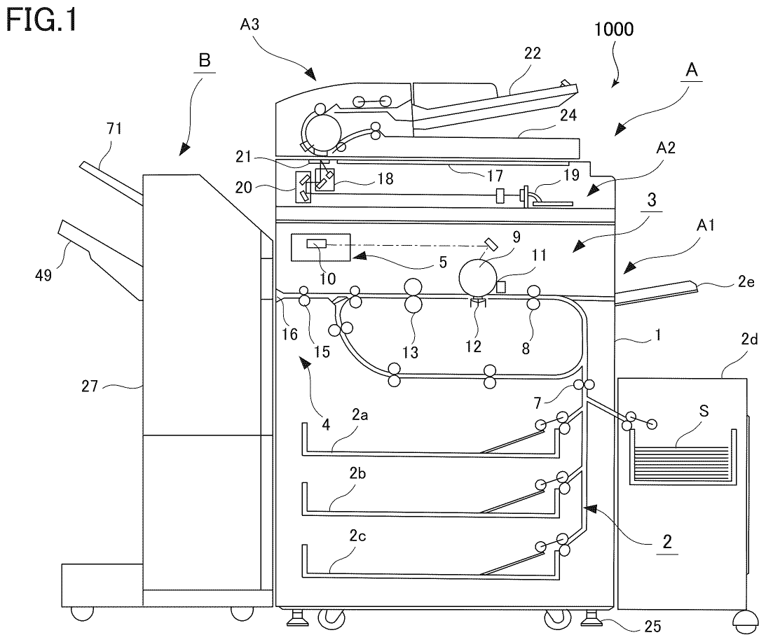

An embodiment will be described with reference to FIGS. 1 to 17B. First, a schematic configuration of an image forming system of the present embodiment will be described with reference to FIG. 1.

### Image Forming System

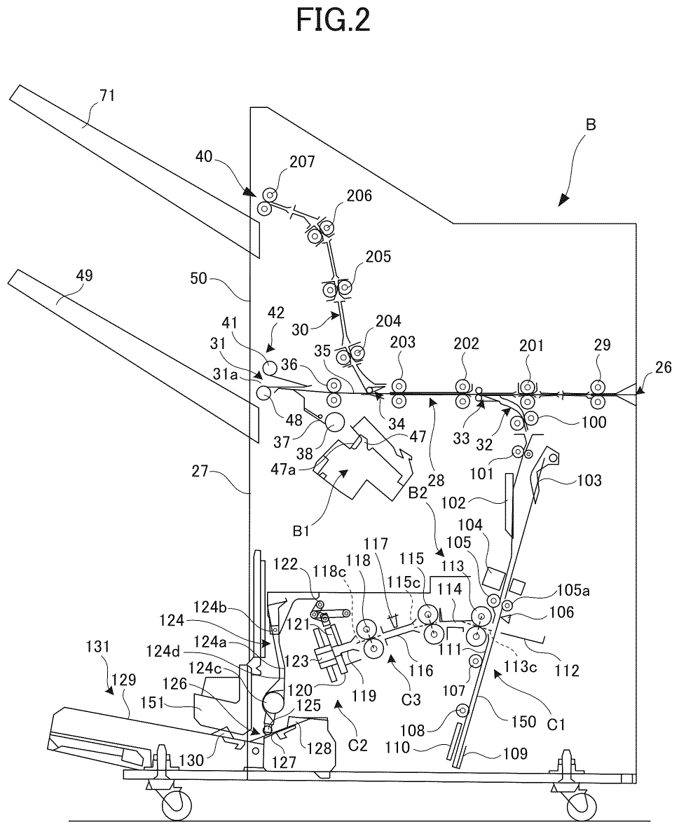

In the present embodiment, a copier is used as the image forming apparatus. A sheet processing apparatus is connected to a sheet discharge port of this copier, and the sheet processing apparatus includes a saddle portion that performs a saddle binding process and a half-folding process. The image forming system 1000 includes an image forming apparatus A and a sheet processing apparatus B. A sheet S on which an image has been formed by the image forming apparatus A is received by the sheet processing apparatus B provided on the downstream side, is subjected to the saddle binding process, the half-folding process, the square back process, and the like if necessary, and is discharged to a discharge portion provided on the downstream side. Examples of the image forming apparatus A include apparatuses of various structures such as copiers, printer, printing machines, facsimile machines, and multifunctional apparatuses having a plurality of functions of these. The image forming apparatus A and the sheet processing apparatus B will be described in detail below. To be noted, in the description below, regarding the image forming apparatus A and the sheet processing apparatus B, the side on which an operator such as a user operates the apparatus (for example, the side on which an operation panel, an operation button, and the like are provided) will be referred to as the front side (F side, front side of the paper surface in FIGS. 1, 2, and the like), and the side opposite to the front side will be referred to as the back side (B side, rear side of the paper surface in FIGS. 1, 2, and the like).

### Image Forming Apparatus

As illustrated in FIG. 1, the image forming apparatus A includes an image forming unit A1, an image reading unit A2, and a document feeding unit A3. The image forming unit A1 includes, in a housing 1, a feeding portion 2, an image forming portion 3, a discharge portion 4, and a data processing portion 5.

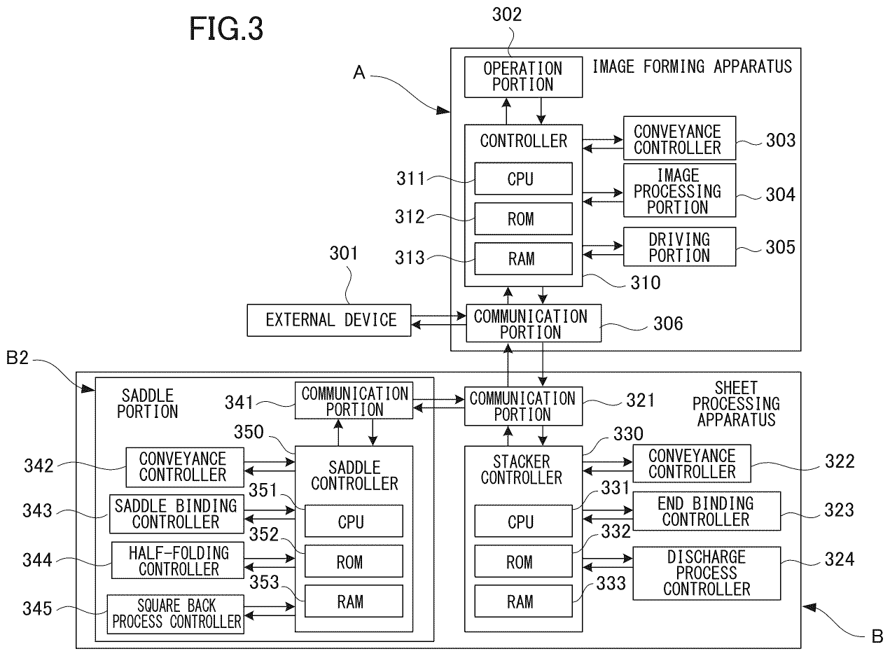

The feeding portion 2 includes a plurality of cassettes 2a, 2b, and 2c, and in the cassettes 2a, 2b, and 2c are capable of accommodating, in a plurality of tiers, sheets S of different regular sizes that are selected in advance. The sheet S is, for example, a paper sheet, a plastic sheet, or the like. The cassettes 2a, 2b, and 2c each include a separation mechanism that separates the sheets S stored therein from each other, and a feeding mechanism that delivers out the sheet S. Regarding the sheet S accommodated in the feeding portion 2 configured in this manner, the sheet S of a size designated by a controller 310 (FIG. 3) of the image forming apparatus A is delivered out. The sheet S fed from one of the plurality of cassettes 2a, 2b, and 2c is conveyed further downstream by a conveyance roller 7. The leading end of the sheet S conveyed by the conveyance roller 7 is aligned by a registration roller pair 8, and thus the skew thereof is corrected. Then, the sheet S whose leading end is aligned by the registration roller pair 8 is fed to the image forming portion 3 provided on the downstream side at a predetermined timing.

A sheet accommodating apparatus 2d and a manual feed tray 2e are coupled to the image forming apparatus A. The sheet accommodating apparatus 2d is constituted by an optional unit that accommodates sheets of a size that is to be consumed by a large amount. The manual feed tray 2e is configured to be capable of supplying special sheets such as cardboard sheets, coated sheets, and film sheets that are difficult to convey while separating the sheets from each other.

It suffices as long as the image forming portion 3 is configured to form an image on the sheet S fed from the feeding portion 2, and various image forming mechanisms can be employed. In the illustrated embodiment, an electrostatic image forming mechanism is illustrated as the image forming portion 3. However, the image forming portion 3 is not limited to the electrostatic image forming mechanism that is illustrated, and an ink jet image forming mechanism, an offset image forming mechanism, and the like can be also employed.

The image forming portion 3 illustrated in FIG. 1 is provided with a photosensitive member 9 formed in a drum shape or a belt shape, an exposing unit 10 that exposes the photosensitive member 9, a developing unit 11 that develops an electrostatic latent image on the photosensitive member 9 by using toner, and a cleaner (not illustrated) that cleans an unillustrated charging unit that charges the photosensitive member 9, the photosensitive member 9, and the like. In FIG. 1, a monochromatic printing mechanism is illustrated as an example. An electrostatic latent image is formed on the photosensitive member 9 by exposure by the exposing unit 10 and is developed by the developing unit 11, and thus a toner image is formed on the photosensitive member 9. The toner image formed on the photosensitive member 9 is, by a transfer unit 12, transferred onto the sheet S conveyed from the registration roller pair 8. The sheet S onto which a toner image has been transferred is fixed by the fixing unit 13. In addition, the image forming apparatus A is provided with a reverse conveyance path, the sheet S to which the toner image has been fixed by a fixing unit 13 is inverted such that the front surface and the back surface thereof are switched and is then conveyed to the registration roller pair 8 again, and image formation is performed on the back surface of the sheet S. A discharge roller 15 is provided downstream of the fixing unit 13 and downstream of a branching point to the reverse conveyance path, and conveys the sheet S from a discharge port 16 of the image forming apparatus A to the sheet processing apparatus B that will be described later.

An image reading unit A2 that optically reads a document image is provided above the image forming unit A1 configured in this manner, and a document feeding unit A3 is further provided above the image reading unit A2.

The image reading unit A2 includes a first platen glass 17, a second platen glass 21, a reading carriage 18 including a light source, a photoelectric conversion element 19, and a reduction optical system 20 constituted by combining mirrors and lenses. Further, the reading carriage 18 is moved in a scanning manner along the first platen glass 17 to irradiate an image of a document placed on the first platen glass 17 with light from the light source, and reflection light from the image of the document is guided to the photoelectric conversion element 19 through the reduction optical system 20 to read the image. The photoelectric conversion element 19 converts image data into an electric signal and transfers the electric signal to the image forming portion 3, and thus the image read by the image reading unit A2 can be formed on a sheet by the image forming unit A1.

The document feeding unit A3 includes a feeding tray 22 and a discharge tray 24, conveys documents placed on the feeding tray 22 one by one through a space on the second platen glass 21, and discharges the document onto the discharge tray 24. To be noted, when reading the document fed by the document feeding unit A3 and passing through the space on the second platen glass 21, the reading carriage 18 is stopped at a position below the second platen glass 21 in advance, and image data is read from an image passing through the space on the second platen glass 21.

### Overall Configuration of Sheet Processing Apparatus

Next, an overall configuration of the sheet processing apparatus B that performs a process such as a stapling process, a folding process, and the like on sheets conveyed from the image forming apparatus A will be described next with reference to FIG. 2. FIG. 2 illustrates a detailed configuration of the sheet processing apparatus B. The sheet processing apparatus B is capable of stacking sheets on a first tray (first stacking tray) 49, a saddle discharge unit 131, and a second tray (second stacking tray) 71 that will be described later after processing the sheets received through an inlet portion 26 serving as an inlet of a conveyance path 28 continuous from the discharge port 16. In the present embodiment, a path refers to the entirety of a path in which a sheet is conveyed by a conveyance guide, a conveyance roller, and the like.

In the illustrated apparatus, the sheet conveyed to the conveyance path 28 serving as a first conveyance path is discharged onto a first tray 49 after being processed by a processing portion B1 that will be described later, or the sheet conveyed in the conveyance path 28 is discharged onto the second tray 71, or is discharged to a saddle discharge unit 131 after being processed by a saddle portion B2 that will be described later. Each apparatus includes a controller, a communication portion, and the like as indicated by blocks representing the overall control configuration of the apparatus illustrated in FIG. 3, and thus the apparatus is controlled.

The processing portion B1 serving as an end binding processing portion is disposed below a path outlet (passing portion 35) of the conveyance path 28, and is capable of accumulating a plurality of sheets sequentially passed on thereto from the conveyance path 28 through the passing portion 35 for each copy to form a sheet bundle, and executing a binding process on an end portion of the sheet bundle. The sheet bundle subjected to the binding process is stacked on the first tray 49 serving as a stacking portion. The trailing end (upstream end) of the sheet or sheet bundle stacked on the first tray 49 abuts a stacking wall 50 provided on the upstream side in the sheet discharge direction of the first tray 49, and is thus stacked along the stacking wall 50.

The first tray 49 is capable of moving up and down with respect to a processing tray 37 that will be described later, and supports thereon a sheet bundle subjected to the binding process by a binding processing mechanism 47 that will be described later. In the present embodiment, the first tray 49 and the second tray 71 are capable of moving up and down by an unillustrated lifting/lowering mechanism. That is, in the present embodiment, when delivering out the sheet onto the first tray 49 or the second tray 71 serving as a stacking tray, the first tray 49 or the second tray 71 is moved up or down to maintain the position of the uppermost sheet on the stacking surface of the tray constant with respect to the discharge roller pair 42 and a second discharge roller 207 such that the alignment of the stacked sheets is not degraded.

The saddle portion B2 is disposed below the passing portion of the saddle path 32 serving as a second conveyance path branching downward in the vertical direction from the conveyance path 28, accumulates a plurality of sheets sequentially passed on thereto from the conveyance path 28 through the saddle path 32 and the passing portion for each copy to form a sheet bundle, performs a folding process after executing a saddle binding process or without performing the saddle binding process, and discharges the sheet bundle to the saddle discharge unit 131. Detailed description of each configuration will be given below.

### Housing

As illustrated in FIG. 2, the sheet processing apparatus B includes a housing 27, the conveyance path 28, the processing portion B1, the saddle portion B2, the first tray 49, the saddle discharge unit 131, the second tray 71, and the like. The conveyance path 28, the processing portion B1, and the saddle portion B2 are disposed inside the housing 27. In addition, the conveyance path 28 includes the inlet portion 26 and the passing portion 35 for the sheet. The processing portion B1 and the saddle portion B2 process the sheet passed on thereto from the passing portion 35 of the conveyance path 28. The first tray 49, the saddle discharge unit 131, and the second tray 71 support thereon a sheet conveyed from each processing portion. The illustrated housing 27 is connected to a housing 1 of the image forming apparatus A positioned upstream thereof in the sheet conveyance direction in the conveyance path 28. Further, the housing 27 and the housing 1 are disposed such that the height of the discharge port 16 of the image forming apparatus A from the installation surface and the height of the inlet portion 26 of the sheet processing apparatus B from the installation surface are approximately equal, and the discharge port 16 and the inlet portion 26 are connected.

### Sheet Introduction Path

The conveyance path 28 serving as a sheet introduction path is configured as an approximately linear path traversing the housing 27 in an approximately horizontal direction, and includes the inlet portion 26 continuous with the discharge port (body discharge port) 16 of the image forming apparatus A and the passing portion 35 positioned on the opposite side across the apparatus with respect to the inlet portion 26. In the conveyance path 28, an inlet roller 29, a first conveyance roller 201, a second conveyance roller 202, and a third conveyance roller 203 serving as conveyance rollers capable of conveying the sheet in a first straight conveyance direction from the inlet portion 26 toward a first discharge path 31 and capable of conveying the sheet in a second straight conveyance direction from the first discharge path 31 toward the inlet portion 26. That is, the inlet roller 29, the first conveyance roller 201, the second conveyance roller 202, and the third conveyance roller 203 are capable of conveying the sheet in the first straight conveyance direction and the second straight conveyance direction opposite to the first straight conveyance direction in the conveyance path, and are arranged in this order from the inlet portion 26 side in the first straight conveyance direction.

The first discharge path 31 is connected to the passing portion 35 of the conveyance path 28, and the first conveyance roller 36 is disposed at a connecting portion of these. The sheet passed on from the conveyance path 28 to the first discharge path 31 and discharged from the first discharge path 31 is stacked on the first tray 49 or guided to the processing portion B1. To be noted, each conveyance roller described above may be a different member capable of conveying a sheet such as a conveyance belt.

### Layout of Sheet Introduction Path

The saddle path 32 and the upper conveyance path 30 that are branch paths are connected to the conveyance path 28 as illustrated in FIG. 2. The saddle path 32 and the upper conveyance path 30 are arranged in this order from the inlet portion 26 toward the first discharge path 31 in the first straight conveyance direction. In addition, the saddle path 32 branches downward from the conveyance path 28 in the vertical direction, and the upper conveyance path 30 branches upward from the conveyance path 28 in the vertical direction. A saddle path switching member 33 and an upper conveyance path switching member 34 serving as switching members that switch the conveyance direction of the conveyed sheet are respectively disposed at the respective branching portions between the conveyance path 28 and the saddle path 32 and between the conveyance path 28 and the upper conveyance path 30.

### Branching Portion of Path

The upper conveyance path switching member 34 is constituted by a switching guide capable of moving to change the conveyance path of the sheet introduced from the inlet portion 26 to convey the sheet to the first discharge path 31 or the upper conveyance path 30, and is moved by a driving portion (not illustrated) such as an electromagnetic solenoid or a mini motor.

### Upper Conveyance Path

The upper conveyance path 30 (print-out discharge path) in which a sheet other than a sheet to be discharged to the first discharge path 31 is conveyed branches from the conveyance path 28, and the upper conveyance path switching member 34 for guiding the sheet to the upper conveyance path 30 is provided at the path branching portion thereof. In addition, in the upper conveyance path 30, a fourth conveyance roller 204, a fifth conveyance roller 205, a sixth conveyance roller 206, and a second discharge roller 207 are provided in the upper conveyance path 30 as conveyance rollers that guide the sheet to the second tray 71. As a result of this, the sheet guided to the upper conveyance path 30 is discharged onto the second tray 71 (overflow tray) from an upper conveyance path discharge port 40.

The processing portion B1 is constituted by a processing tray 37 serving as a placement portion that places thereon a sheet conveyed through the first discharge path 31 provided downstream of the conveyance path 28 and accumulates a plurality of placed sheets for each copy, and a binding processing mechanism 47 that performs a binding process on the accumulated sheet bundle. Further, the processing portion B1 performs a binding process on the sheet bundle placed on the processing tray 37. The binding processing mechanism 47 is disposed below the conveyance path 28 in the vertical direction. As illustrated in FIG. 2, a step is formed in the first discharge path 31, and the processing tray 37 is disposed below the step. A first switchback path in which the sheet is guided onto the processing tray 37 after reversing the conveyance direction in a state in which part of the sheet has been discharged onto the first tray 49 through the discharge port 31a of the first discharge path 31 is provided between the first discharge path 31 and the processing tray 37.

Specifically, in the first discharge path 31, an upper conveyance roller 41 and a lower conveyance roller 48 that nip and convey the sheet are provided. The upper conveyance roller 41 and the lower conveyance roller 48 constitute a discharge roller pair 42 serving as a discharge portion. The upper conveyance roller 41 is capable of coming into and out of contact with and from the lower conveyance roller 48, and the sheet can be conveyed in a direction toward the first tray 49 and a direction opposite to this direction in a state in which the sheet is nipped between the upper conveyance roller 41 and the lower conveyance roller 48. Further, the sheet can be conveyed toward the processing tray 37 through the first switchback path by the upper conveyance roller 41 and the lower conveyance roller 48.

In addition, the upper conveyance roller 41 and the lower conveyance roller 48 (that is, the discharge roller pair 42) discharge the sheet or sheet bundle on the processing tray 37 onto the first tray 49 serving as a stacking tray (stacking portion) through the discharge port 31a. The discharge port 3 la is a portion opening at a position above the lower conveyance roller 48 in the housing 27. Further, the discharge roller pair 42 discharges the sheet conveyed to the first discharge path 31 without passing the processing tray 37 onto the first tray 49 through the discharge port 31a.

The binding processing mechanism 47 includes a trailing end regulating portion 47a that abuts an end portion (trailing end) of the sheet and positions the sheet. A reversing portion 38 that conveys the sheet conveyed to the processing tray 37 by the upper conveyance roller 41 and the lower conveyance roller 48 toward the trailing end regulating portion 47a is disposed on the processing tray 37. Further, the binding processing mechanism 47 performs a binding process on an end portion of a sheet bundle constituted by a plurality of sheets which are placed on the processing tray 37 and a position of an end portion of which is regulated by the trailing end regulating portion 47a. In addition, the binding processing mechanism 47 includes a sheet bundle discharge mechanism that discharges the sheet bundle onto the first tray 49 after performing the binding process on the end portion of the sheet bundle.

To be noted, the binding processing mechanism 47 illustrated in FIG. 2 supports the sheet conveyed from the first discharge path 31 such that the sheet bridges the processing tray 37 and the first tray 49 provided downstream thereof. That is, the sheet conveyed from the first discharge path 31 is supported such that the leading end portion of the sheet is supported on the uppermost sheet on the first tray 49 provided on the downstream side, and the trailing end portion of the sheet is supported on the processing tray 37.

### Saddle Path

The saddle path 32 for conveying the sheet to the saddle portion B2 described above is coupled to the conveyance path 28, and the saddle path switching member 33 for guiding the sheet to the saddle path 32 is provided at the path branching portion thereof. The sheet guided to the saddle portion B2 through the saddle path 32 is subjected to the half-folding process, and after being subjected to the folding process, is discharged to the saddle discharge unit 131 via a post-folding path guide 114, a post-second roller path guide 116, a pre-clamp guide 119, and a saddle discharge guide 124. In the present embodiment, the saddle discharge guide 124 serving as a discharge guide portion is used as an auxiliary guide for appropriately stacking the sheet on the saddle discharge unit 131.

### Control Configuration

The outline of a control configuration of the image forming system 1000 will be described with reference to FIG. 3. First, the image forming apparatus A includes a controller 310, an operation portion 302, a conveyance controller 303, an image processing portion 304, a driving portion 305, and a communication portion 306. The controller 310 includes a central processing unit: CPU 311, a read-only memory: ROM 312, and a random access memory: RAM 313. The CPU 311 controls each component while reading out a program corresponding to a control procedure stored in the ROM 312. In addition, the RAM 313 stores work data and input data, and the CPU 311 performs control with reference to data stored in the RAM 313 on the basis of the program described above and the like.

The operation portion 302 is, for example, an operation panel provided in the image forming apparatus A and connected to the controller 310, and an operator operates the apparatus and performs various settings thereby. The conveyance controller 303 controls the various conveyance rollers that convey the sheet and the switching members that switch the conveyance path in the image forming apparatus A. The image processing portion 304 controls the image forming portion 3. The driving portion 305 controls various motors and the power source. The communication portion 306 communicably connects an external device 301 such as a personal computer and a communication portion 321 of the sheet processing apparatus B with the controller 310.

The sheet processing apparatus B includes a stacker controller 330, a conveyance controller 322, an end binding controller 323, a discharge process controller 324, and the communication portion 321. The stacker controller 330 includes a CPU 331, a ROM 332, and a RAM 333 similarly to the controller 310. The conveyance controller 322 controls the various conveyance rollers that convey the sheet and the switching members that switch the conveyance path in part of the sheet processing apparatus B other than the saddle portion B2. The end binding controller 323 controls the processing portion B1. The discharge process controller 324 controls various stacking trays onto which sheets are discharged and on which the discharged sheets are stacked. The communication portion 321 communicably connects the communication portion 306 of the image forming apparatus A and a communication portion 341 of the saddle portion B2 with the stacker controller 330. To be noted, the communication between the communication portion 306 and the communication portion 321 may be performed by wired communication or wireless communication.

The saddle portion B2 includes a saddle controller 350, a conveyance controller 342, a saddle binding controller 343, a half-folding controller 344, a square back process controller 345, and a communication portion 341. The saddle controller 350 includes a CPU 351, a ROM 352, and a RAM 353 similarly to the controller 310. The conveyance controller 342 controls the various conveyance rollers that convey the sheet and the switching members that switch the conveyance path in the saddle portion B2. The saddle binding controller 343 controls the saddle binding processing portion 104. The half-folding controller 344 controls a half-folding processing mechanism C1. The square back process controller 345 controls a square back processing portion C2. The communication portion 341 communicably connects the communication portion 321 of the sheet processing apparatus B with the saddle controller 350. To be noted, although a configuration in which the saddle controller 350 communicates with the stacker controller 330 via the communication portions 341 and 321 is employed in the present embodiment, a configuration in which each unit is controlled by the same controller may be employed. In addition, although the conveyance controller 322, the end binding controller 323, the discharge process controller 324, the stacker controller 330, and the saddle controller 350 are provided as elements that control the sheet processing apparatus B in the present embodiment, a configuration in which each unit is controlled by the same controller may be employed.

### Saddle Portion

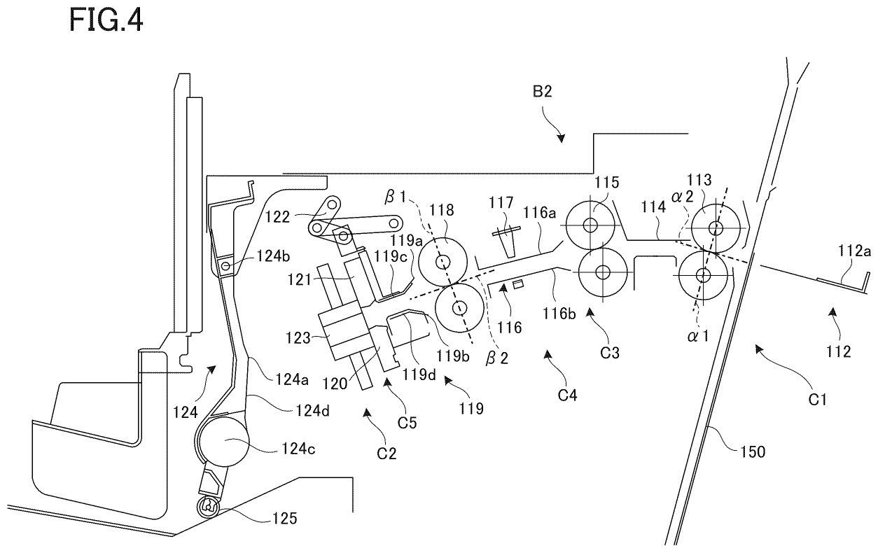

The saddle portion B2 will be described with reference to FIGS. 2 and 4. The saddle portion B2 includes the half-folding processing mechanism C1 and the square back processing portion C2, and performs a half-folding process, a saddle binding process, and a square back process as a predetermined process. The predetermined process may be any one of these processes, or a plurality of processes among these. The half-folding processing mechanism C1 accumulates sheets conveyed from the conveyance path 28 for each copy to form a sheet bundle, performs a binding process on a center portion in the conveyance direction (center portion in a second conveyance direction that is a conveyance direction of the saddle path roller 100 serving as a second conveyance portion that will be described later) of the sheet bundle, and performs a half-folding process (hereinafter also referred to as a “magazine finish”) in which the sheet bundle is folded at a position subjected to the binding process. The square back processing portion C2 is disposed downstream of the half-folding processing mechanism C1 in the conveyance direction of the sheet bundle (downstream in the first conveyance direction that is the conveyance direction of a saddle third roller pair 118 serving as a first conveyance portion that will be described later), and performs a square back process of forming a folding line on the spine of the sheet bundle subjected to the half-folding process. Further, the saddle discharge unit 131 is disposed downstream of the square back processing portion C2 in the first conveyance direction, and the sheet bundle subjected to a bookbinding process is stacked on the saddle discharge unit 131. To be noted, only the half-folding process of folding the center portion of the sheet in the conveyance direction may be performed without performing the saddle binding process and the square back process after accumulating one sheet or a plurality of sheets for each copy.

### Half-Folding Mechanism

The half-folding processing mechanism C1 includes a leading end regulating stopper 109, a saddle binding processing portion (saddle binding stapling unit) 104, and a half-folding processing portion 112, accumulates sheets into a bundle shape, and performs the half-folding process and the saddle binding process. That is, the sheet conveyed from the conveyance path 28 to the saddle path 32 is conveyed to the saddle stacking tray 150 serving as an accumulation portion and a second accumulation portion by the saddle path roller 100 serving as a second conveyance portion. The saddle stacking tray 150 forms a sheet bundle by accumulating a plurality of sheets conveyed in the second conveyance direction by the saddle path roller 100 through the saddle path 32. The sheet bundle accumulated on the saddle stacking tray 150 is positioned at a predetermined position on the saddle stacking tray 150 by the leading end regulating stopper 109. The saddle binding processing portion 104 performs the binding process on a center portion in the conveyance direction (middle portion in the second conveyance direction) of the sheet bundle positioned by the leading end regulating stopper 109. The half-folding processing portion 112 includes the folding plate 112a and the folding roller pair 113, and by conveying the sheet bundle by the folding roller pair 113 while poking the vicinity of the position subjected to the binding process by the saddle binding processing portion 104 (center portion in the conveyance direction of the sheet bundle in the binding process) by the folding plate 112a, the sheet bundle is folded and conveyed such that the spine of the sheet bundle is on the downstream side in the conveyance direction. To be noted, the half-folding processing portion 112 is also capable of performing the half-folding process on a sheet bundle (or a single sheet) not subjected to the binding process. Here, the half-folding process is a process of folding the sheet bundle in half by forming a folding line near the center of the sheet bundle. The folding line formed by the half-folding processing portion 112 does not need to be positioned at the center of the sheet bundle, and may be displaced from the center within the range of the tolerance of parts. In addition, the folding position may be changed by user settings.

The saddle binding processing portion 104 is a mechanism that performs the binding process of moving a head unit and an anvil unit along the sheet center portion (line) while nipping the sheet bundle between the head unit and the anvil unit. In addition, for the half-folding processing portion 112, as illustrated in FIGS. 2 and 4, a configuration in which the sheet bundle is inserted in the nip of the folding roller pair 113 in pressure contact with each other by the folding plate 112a, and the sheet bundle is conveyed while being folded by the rotation of the folding roller pair 113 is employed.

### Square Back Processing Portion

The square back processing portion C2 performs, on the sheet bundle, the square back process to form a square back shape along the folding line of the sheet bundle subjected to the half-folding process. The square back processing portion C2 includes a lower clamp unit 120 and an upper clamp unit 121 serving as a pair of clamp portions (nipping unit), and a square back processing unit 134 including a pressing roller 123.

The lower clamp unit 120 and the upper clamp unit 121 relatively move along the thickness direction (direction in which a virtual line connecting rotational axes of the saddle third roller pair 118 extends, or direction orthogonal to the conveyance direction 118c of the saddle third roller pair 118) of the sheet bundle conveyed by a saddle third roller pair 118 that will be described later, and thus nip the sheet bundle and release the nipping of the sheet bundle. The pressing roller 123 moves along the width direction of the sheet bundle (direction orthogonal to the conveyance direction of the sheet bundle, front-rear direction of FIGS. 2 and 4), and thus presses the spine of the sheet bundle. Further, the square back processing portion C2 performs a square back process of forming a corner on the spine of the sheet bundle by pressing, by the pressing roller 123, the spine of the sheet bundle nipped between the lower clamp unit 120 and the upper clamp unit 121 in a state in which the spine of the sheet bundle protrudes downstream with respect to the lower clamp unit 120 and the upper clamp unit 121 in the first conveyance direction. To be noted, examples of the “corner” described above include a curved surface, and refers to a boundary between the front cover and the spine of the sheet bundle and a boundary between the spine and the back cover of the sheet bundle. In addition, the “width direction of the sheet bundle” is a direction along the front-rear direction (F-B direction) of the image forming apparatus A and the sheet processing apparatus B, and may be simply referred to as a “width direction” in the description below.

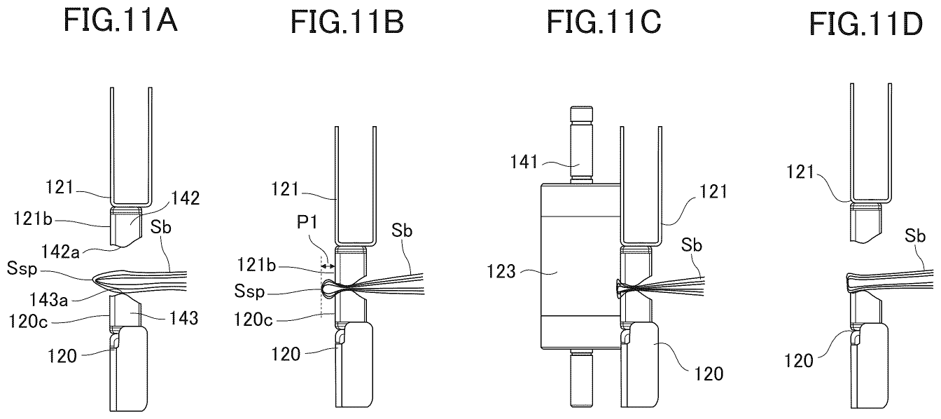

Specifically, the square back processing portion C2 nips part of the sheet bundle from both sides in the vertical direction (thickness direction of the sheet bundle) by the lower clamp unit 120 and the upper clamp unit 121 in a state in which the spine of the sheet bundle subjected to the half-folding by the half-folding processing mechanism C1 protrudes downstream in the first conveyance direction. The pressing roller 123 presses the spine of the sheet bundle nipped between the lower clamp unit 120 and the upper clamp unit 121, while moving in the width direction of the sheet bundle orthogonal to the conveyance direction of the sheet bundle and to the thickness direction of the sheet bundle. In this manner, the square back processing portion C2 performs the square back process of forming a corner on the spine of the sheet bundle. The square back process is a process of forming two corners on the spine of the sheet bundle by forming two streaks on the spine of the sheet bundle as illustrated in FIGS. 11C and 11D by crushing the spine of the sheet bundle illustrated in FIGS. 11A and 11B that will be described later by the pressing roller 123. The two corners on the spine of the sheet bundle are formed at positions between which the staples embedded in the sheet bundle in the binding process by the saddle binding processing portion 104 are positioned in the thickness direction of the sheet bundle. In addition, the two corners formed on the spine of the sheet bundle are formed at positions between which a folding line formed in the half-folding process by the half-folding processing portion 112 is positioned.

To be noted, a half-folding conveyance mechanism that conveys the sheet bundle subjected to the half-folding process by the half-folding processing mechanism C1 to the square back processing portion C2 positioned downstream and stops the conveyance is disposed between the half-folding processing mechanism C1 and the square back processing portion C2.

As described above, the processing portion B1 and the conveyance path 28 are arranged in approximately the horizontal direction, the saddle path 32 that guides the sheet to the saddle portion B2 is disposed in approximately the vertical direction, and the saddle stacking tray 150 that accumulates the sheets for each copy is disposed to approximately follow the vertical direction. As described above, by disposing the conveyance path 28 along a direction traversing the housing 27 and disposing the saddle path 32 and the saddle portion B2 along approximately the vertical direction, the apparatus can be made slimer, that is, the width of the apparatus in the horizontal direction can be reduced.

The saddle discharge unit 131 is disposed downstream of the saddle portion B2 in the conveyance direction of the sheet bundle, and accommodates a sheet bundle folded into a magazine shape. The saddle discharge unit 131 that is illustrated is disposed below the first tray 49 in the vertical direction. This is because the apparatus has specifications set in consideration of the fact that the frequency of use of the first tray 49 is higher than the frequency of use of the saddle discharge unit 131 and the first tray 49 is set to a height where the sheet on the tray is easy to pick up.

### Configuration of Saddle Portion

Next, the configuration of each of the half-folding processing mechanism C1, the half-folding conveyance mechanism C3, and the square back processing portion C2 constituting the saddle portion B2 will be described in more detail.

### Details of Half-Folding Processing Mechanism

As illustrated in FIG. 2, the saddle path switching member 33 is switched so as to convey the sheet to the saddle path 32, and thus guides the sheet to the half-folding processing mechanism C1. A saddle inlet roller 101, a sorting portion 102, a trailing end pressing guide 103, a saddle binding processing portion 104, a pull-in separation roller 105, a half-folding processing portion 112, a first alignment roller 107, a second alignment roller 108, a leading end regulating stopper 109, and a leading end gripper 110 are disposed in this order from the upper side (upstream side) in the vertical direction that is the inlet side in the height direction of the half-folding processing mechanism C1.

The saddle inlet roller 101 conveys the sheet passed on thereto from the saddle path 32 by the saddle path roller 100 further downward. The sorting portion 102 moves the sheet conveyed downward from the saddle inlet roller 101 to the right side in FIG. 2, and accumulates the sheet on the saddle stacking tray 150. The trailing end pressing guide 103 presses the trailing end of the sheet stacked on the saddle stacking tray 150. The saddle binding processing portion 104 performs the binding process on the center portion in the conveyance direction of the sheet bundle accumulated on the saddle stacking tray 150. The pull-in separation roller 105 supports the conveyance of the sheet conveyed to the saddle stacking tray 150, and is a roller that pulls in this sheet toward the leading end regulating stopper 109. The pull-in separation roller 105 is disposed so as to be capable of coming into contact and out of contact with and from an opposing roller 105a.

The half-folding processing portion 112 includes a folding roller pair 113, the folding plate 112a serving as a pressing portion, and a roller guide 111. The folding roller pair 113 forms a folding line in the half-folding process. The folding plate 112a pushes the sheet into the nip portion of the folding roller pair 113. The roller guide 111 covers the folding roller pair 113. The first alignment roller 107 and the second alignment roller 108 convey the sheet conveyed to the saddle stacking tray 150, and aligns the sheet in the height direction of the sheet. The leading end regulating stopper 109 abuts the leading end (lower end) of the sheet conveyed thereto, and determines the position of the leading end of the sheet in the height direction. The leading end gripper 110 presses the leading end (lower end) of the sheet stacked on the leading end regulating stopper 109.

The saddle inlet roller 101 and the pull-in separation roller 105 are driven by the same motor. The trailing end pressing guide 103 is provided at a position opposing the sorting portion 102 with respect to the saddle stacking tray 150. The saddle binding processing portion 104 is disposed downstream of the sorting portion 102 and the trailing end pressing guide 103 and upstream of the pull-in separation roller 105.

The sheet conveyed from the saddle path 32 to the saddle portion B2 is conveyed to the leading end regulating stopper 109 moved to a position corresponding to the size by the saddle inlet roller 101. The pull-in separation roller 105 has an auxiliary conveyance function for precisely conveying the conveyed sheet to the leading end regulating stopper 109 in the saddle stacking tray 150. The roller guide 111 partially covers the folding roller pair 113 so as to suppress the leading end of the sheet getting caught at the folding roller pair 113 at this time and efficiently convey the sheet.

The first alignment roller 107 and the second alignment roller 108 cause the conveyed sheet to precisely abut the leading end regulating stopper 109, and thus performs an alignment process in the sheet height direction.

The sorting portion 102 moves the sheet conveyed to the leading end regulating stopper 109 to the trailing end pressing guide 103, and by pressing the trailing end (upper end) of the moved sheet by the trailing end pressing guide 103, preparation for receiving the next sheet is performed. At this time, the trailing end pressing guide 103 has moved to a position corresponding to the size and is standing by.

The leading end (trailing end) of the sheet bundle formed by stacking a plurality of sheets on the saddle stacking tray 150 is fixed by being gripped by the leading end gripper 110. In this state, the binding process is performed on the center portion in the second conveyance direction of the sheet bundle by the saddle binding processing portion 104. After the binding process, the leading end regulating stopper 109 is moved down while the leading end (lower end) of the sheet bundle is still gripped by the leading end gripper 110. At this time, by moving down the leading end regulating stopper 109 such that the position in the sheet where the sheet is pushed into the folding roller pair 113 by the folding plate 112a is a position of ½ of the sheet size, the sheet bundle is moved down from the binding position.

When performing the half-folding process, the roller guide 111 is retracted, the fixation by the leading end gripper 110 is released, and then the center portion of the sheet bundle is pushed into the nip portion of the folding roller pair 113 by the folding plate 112a. As a result of this, the half-folding process is performed on the sheet bundle.

The saddle inlet roller 101, the pull-in separation roller 105, the sorting portion 102, and the trailing end pressing guide 103 are controlled by the conveyance controller 342 (FIG. 3). In addition, the leading end regulating stopper 109, the leading end gripper 110, the saddle binding processing portion 104, the first alignment roller 107, and the second alignment roller 108 are controlled by the saddle binding controller 343 (FIG. 3). Further, the folding roller pair 113 and the folding plate 112a are controlled by the half-folding controller 344 (FIG. 3).

### Half-Folding Conveyance Mechanism

The configuration of the half-folding conveyance mechanism C3 will be described with reference to FIGS. 2 and 4. The half-folding conveyance mechanism C3 is a mechanism that passes on the sheet bundle subjected to the half-folding process by the half-folding processing mechanism C1 to the square back processing portion C2. Specifically, the half-folding conveyance mechanism C3 first conveys the sheet bundle subjected to the half-folding process as it is by the folding roller pair 113 such that the spine of the sheet bundle is positioned downstream of the fore edge in the conveyance direction, and passes on the sheet bundle to the post-folding path guide 114. The post-folding path guide 114 is disposed at a position downstream of the folding roller pair 113 in the conveyance direction and is disposed along a direction (approximately horizontal direction herein) bending downward in the vertical direction from a folding roller conveyance direction 113c (FIG. 2) following a line (first virtual line α2 that will be described later, FIG. 4) perpendicular to a straight line passing through the rotational center of each roller of the folding roller pair 113 serving as a first conveyance roller pair.

Here, as illustrated in FIG. 4, a straight line orthogonal to a first line α1 passing through the rotational centers of the folding roller pair 113 and to the width direction (direction orthogonal to the conveyance direction of the sheet bundle, front-rear direction of FIGS. 2 and 4) and passing through the nip of the folding roller pair 113 not nipping the sheet bundle is set as the first virtual line α2. In this case, the folding roller pair 113 is disposed such that the first virtual line α2 is parallel to the horizontal direction or is inclined upward in the vertical direction toward the downstream side in the conveyance direction with respect to the horizontal direction. In the present embodiment, the first virtual line α2 is inclined upward in the vertical direction toward the downstream side in the conveyance direction with respect to the horizontal direction. In contrast, the post-folding path guide 114 is provided to extend in a direction inclined with respect to the first virtual line α2, and is provided to extend approximately in the horizontal direction in the present embodiment.

The post-folding path guide 114 guides the conveyance of the sheet bundle, and guides the sheet bundle to a saddle second roller pair 115 positioned on the downstream side in the conveyance direction. A saddle second roller conveyance direction 115c that is a direction following a line perpendicular to a straight line passing through the rotational center of each roller of the saddle second roller pair 115 is provided along a direction inclined downward in the vertical direction toward the downstream side in the conveyance direction. The saddle second roller pair 115 is driven by the half-folding controller 344 and conveys the sheet bundle.

The sheet bundle conveyed by the saddle second roller pair 115 is passed on to the post-second roller path guide 116 disposed on the downstream side in the conveyance direction and disposed parallel to the saddle second roller conveyance direction 115c (FIG. 2), and is guided by the post-second roller path guide 116. In addition, the post-second roller path guide 116 includes a post-second roller path upper guide 116a that guides the upper surface of the sheet bundle and a post-second roller path lower guide 116b that guides the sheet bundle. A saddle conveyance sensor 117 is disposed at a position above the guide surface of the post-second roller path upper guide 116a and between the inlet port for the sheet bundle and the discharge port for the sheet bundle. The saddle conveyance sensor 117 detects the position of the leading end of the sheet bundle.

The post-second roller path guide 116 guides the conveyance of the sheet, and guides the sheet to the saddle third roller pair 118 positioned downstream in the conveyance direction. A saddle third roller conveyance direction 118c (FIG. 2) that is a direction following a line (second virtual line β2 that will be described next, FIG. 4) perpendicular to a straight line passing through the rotational center of each roller of the saddle third roller pair 118 is provided along a direction inclined downward in the vertical direction toward the downstream side in the conveyance direction.

The saddle third roller pair 118 serving as a conveyance portion and a conveyance roller pair is driven by the half-folding controller 344, and nips and conveys the sheet bundle subjected to the saddle binding process and the half-folding process such that the spine of the sheet bundle is positioned downstream of an end portion on the fore edge side in the conveyance direction. That is, the saddle third roller pair 118 conveys the sheet bundle such that the spine of the sheet bundle serves as the leading end. In the case where the direction in which the sheet bundle is conveyed by the saddle third roller pair 118 also serving as a first conveyance portion is set as the first conveyance direction (saddle third roller conveyance direction 118c), the saddle path roller 100 serving as a second conveyance portion that conveys the sheet to the half-folding processing mechanism C1 is positioned upstream of the saddle third roller pair 118 in the first conveyance direction. Further, the saddle path roller 100 conveys the sheet in a second conveyance direction different from the first conveyance direction at a position upstream of the saddle third roller pair 118 in the first conveyance direction. In the description below, the upstream side and the downstream side in the first conveyance direction (saddle third roller conveyance direction 118c) in which the sheet bundle is conveyed by the saddle third roller pair 118 may be sometimes simply referred to as the “upstream side” and the “downstream side”.

To be noted, the folding roller pair 113, the saddle second roller pair 115, and the saddle third roller pair 118 are driven by the same motor, and the half-folding controller 344 controls this motor to control the driving of each roller pair. The saddle third roller pair 118 nips the sheet bundle subjected to half-folding by the half-folding processing portion 112, conveys the sheet bundle toward the square back processing portion C2, and is positioned immediately upstream of the square back processing portion C2.

Here, as illustrated in FIG. 4, a straight line that is orthogonal to a second line β1 passing through the rotational centers of the saddle third roller pair 118 and to the width direction and that passes the nip of the saddle third roller pair 118 not nipping the sheet bundle is set as a second virtual line β2. In this case, the saddle third roller pair 118 is provided such that the second virtual line β2 intersects with the first virtual line α2 and is inclined downward in the vertical direction toward the downstream side of the folding roller pair 113 in the conveyance direction.

In other words, the saddle third roller pair 118 is disposed such that the second virtual line β2 is inclined downward in the vertical direction toward the downstream side in the conveyance direction with respect to the horizontal direction. That is, in the present embodiment, the second virtual line β2 is inclined with respect to the first virtual line α2. Further, the folding roller pair 113 conveys the sheet bundle in the horizontal direction or a direction (folding roller conveyance direction 113c) inclined upward in the vertical direction toward the downstream side in the conveyance direction with respect to the horizontal direction. In contrast, the saddle third roller pair 118 conveys the sheet bundle in a direction (saddle third roller conveyance direction 118c) inclined downward in the vertical direction toward the downstream side in the conveyance direction with respect to the horizontal direction.

Therefore, in the case of the present embodiment, the half-folding conveyance path C4 serving as a third conveyance path in which the sheet bundle is conveyed between the folding roller pair 113 and the saddle third roller pair 118 is bent such that the sheet bundle conveyed by the folding roller pair 113 is passed on to the saddle third roller pair 118. That is, the half-folding conveyance path C4 includes the post-folding path guide 114 and the post-second roller path guide 116, and the conveyance path between the post-folding path guide 114 and the post-second roller path guide 116 is bent. In other words, the direction in which the sheet bundle is guided by the post-second roller path guide 116 is inclined with respect to the direction in which the sheet bundle is guided by the post-folding path guide 114.

As described above, by making the conveyance direction of the sheet bundle by the folding roller pair 113 and the conveyance direction of the sheet bundle by the saddle third roller pair 118 different and bending the conveyance path between the post-folding path guide 114 and the post-second roller path guide 116, the width (length in the second conveyance direction, length in the left-right direction of FIG. 2) of the sheet processing apparatus B can be reduced, and thus the apparatus can be miniaturized. In addition, by discharging the sheet bundle downward by the saddle third roller pair 118 with the folding roller conveyance direction 113c serving as the sheet conveyance direction of the saddle third roller pair 118 directed diagonally downward, the sheet bundle processed by the saddle portion B2 can be discharged to a position lower in the apparatus. As a result of this, the saddle discharge unit 131 to which the sheet bundle processed by the saddle portion B2 is discharged can be disposed in a lower portion of the apparatus, and thus the amount by which the first tray 49 positioned above the saddle discharge unit 131 can be moved down can be increased. As a result of this, the sheet stacking amount of the first tray 49 can be increased. To be noted, in the case where “horizontal”, “vertical”, “parallel”, and the like are mentioned in the layout of the conveyance path guides for the sheet or sheet bundle and the conveyance direction of the sheet or sheet bundle, cases where an angle is formed with respect to the horizontal direction, the vertical direction, or the parallel direction due to the tolerance or the like are also included.

### Details of Square Back Processing Portion

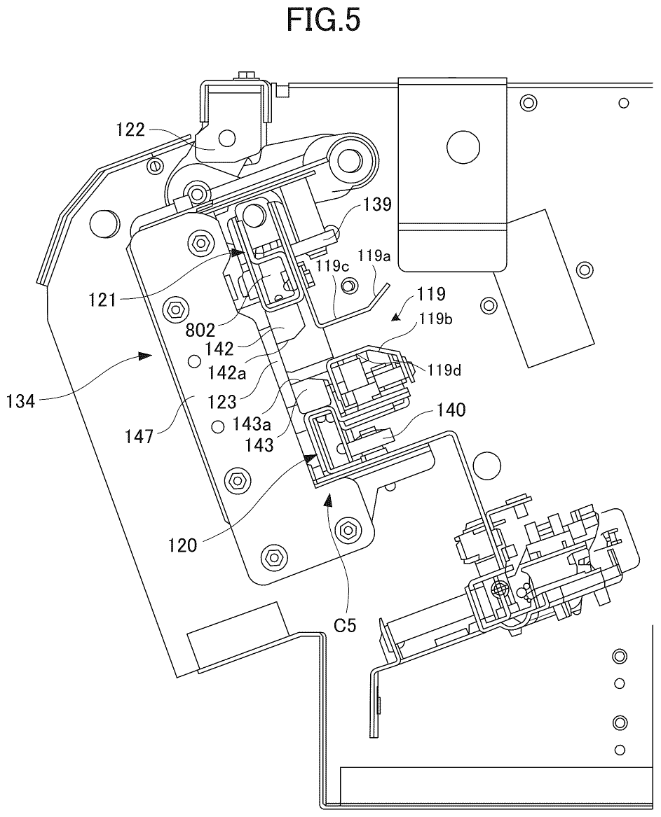

The square back processing portion C2 will be described by using FIGS. 5 to 10 with reference to FIGS. 2 and 4. As described above, the square back processing unit 134 including the lower clamp unit 120 and the upper clamp unit 121 serving as a pair of clamp portions and the pressing roller 123 is provided. A clamping mechanism C5 including the lower clamp unit 120 and the upper clamp unit 121 includes a pre-clamp guide 119 as illustrated in FIG. 5. The pre-clamp guide 119 is disposed at a position downstream of the saddle third roller pair 118 in the conveyance direction and is disposed along a direction bent downward in the vertical direction with respect to the saddle third roller conveyance direction 118c, and guides the conveyance of the sheet bundle.

The pre-clamp guide 119 includes a pre-clamp upper guide portion 119a serving as a first guide portion that guides the upper surface of the sheet bundle, and a pre-clamp lower guide portion 119b serving as a second guide portion that guides the lower surface of the sheet bundle. The pre-clamp upper guide portion 119a and the pre-clamp lower guide portion 119b are disposed at positions apart from a line centered on the saddle third roller conveyance direction 118c by a distance larger than a half of the maximum thickness of the sheet bundle that can be passed through the apparatus (the thickness of the sheet bundle after performing the half-folding process on the sheet bundle of the maximum thickness that can be conveyed in the apparatus). That is, the distance between the pre-clamp upper guide portion 119a and the pre-clamp lower guide portion 119b is larger than the maximum thickness of the sheet bundle that can be processed by the sheet processing apparatus B (maximum thickness of the sheet bundle that can be subjected to the half-folding process by the half-folding processing mechanism C1). To be noted, at least one of the pre-clamp upper guide portion 119a and the pre-clamp lower guide portion 119b may be omitted.

The lower clamp unit 120 and the upper clamp unit 121 serving as a pair of clamp units relatively move along the thickness direction of the sheet bundle conveyed by the saddle third roller pair 118, and thus nips the sheet bundle and release the nipping. That is, the lower clamp unit 120 and the upper clamp unit 121 are relatively movable to a first position where the sheet bundle conveyed from the saddle third roller pair 118 can be received and a second position where the sheet bundle is nipped. Further, the lower clamp unit 120 and the upper clamp unit 121 move from the first position to the second position and thus nip part of the sheet bundle from both sides in the thickness direction of the sheet bundle.

In the case of the present embodiment, the upper clamp unit 121 serving as a first clamp portion is movable, and the lower clamp unit 120 serving as a second clamp portion is fixed. That is, the upper clamp unit 121 moves in a direction to approach the lower clamp unit 120, and thus the sheet bundle is nipped. To be noted, a configuration in which the upper clamp unit 121 is fixed and the lower clamp unit 120 is movable may be employed, and a configuration in which both of these are movable may be employed. In either case, an upper clamping surface (upper clamping pressing portion) 142 of the upper clamp unit 121 that is a surface opposing the lower clamp unit 120 and a lower clamping surface (lower clamping pressing portion) 143 of the lower clamp unit 120 that is a surface opposing the upper clamp unit 121 nip the sheet bundle (see FIGS. 5 and 11A to 11D).

The lower clamping surface 143 of the lower clamp unit 120 and the upper clamping surface 142 of the upper clamp unit 121 are respectively parallel to the pre-clamp upper guide portion 119a and the pre-clamp lower guide portion 119b and are disposed downstream of the pre-clamp guide 119 in the conveyance direction of the sheet bundle. Further, the sheet bundle conveyed while being guided by the pre-clamp guide 119 is conveyed by a predetermined amount while further being guided by the upper clamping surface 142 and the lower clamping surface 143. To be noted, the pre-clamp lower guide portion 119b and the pre-clamp upper guide portion 119a are respectively fixed to the lower clamp unit 120 and the upper clamp unit 121. In the present embodiment, the pre-clamp upper guide portion 119a moves approximately in the vertical direction (thickness direction of the sheet bundle) together with the upper clamp unit 121.

### Square Back Processing Unit

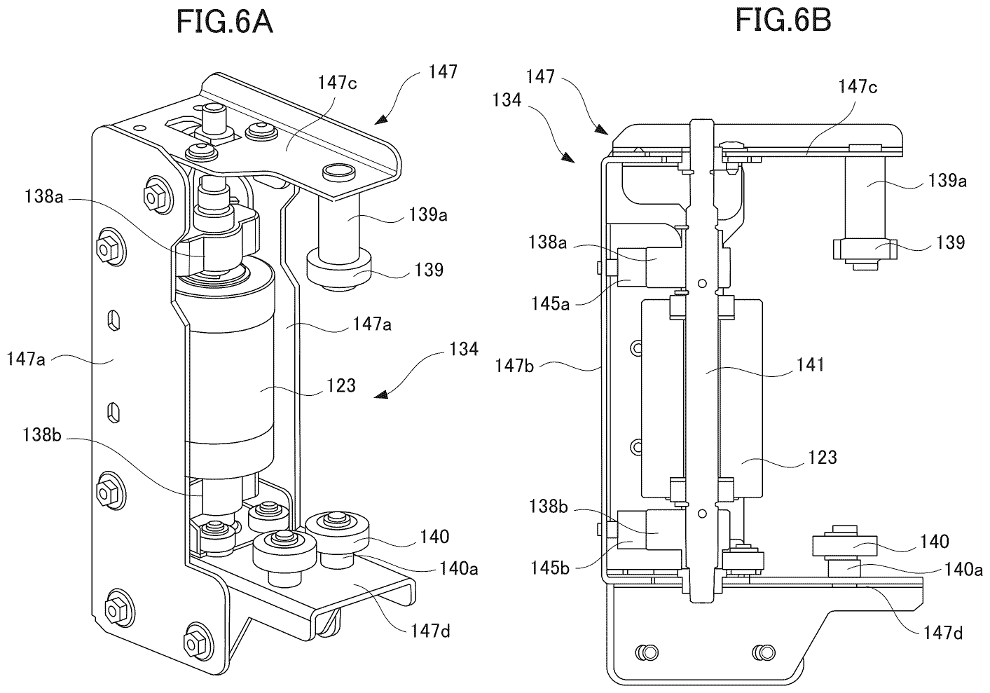

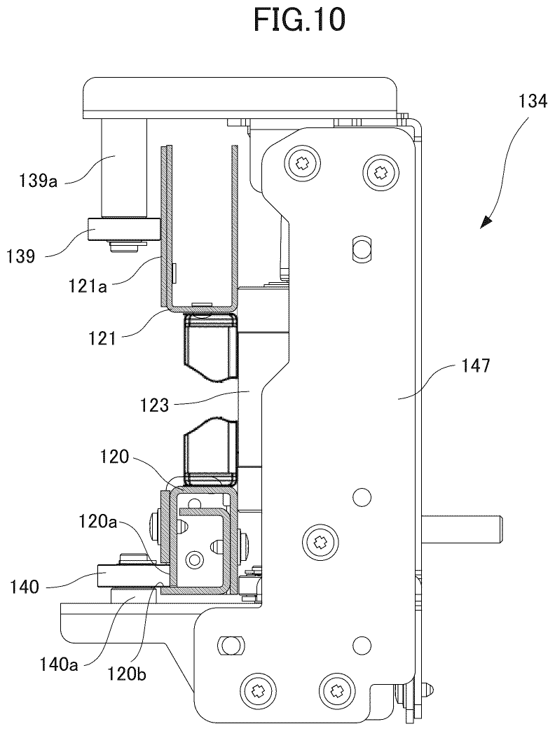

Next, an inner configuration of the square back processing unit 134 will be described with reference to FIGS. 5 to 10. The square back processing unit 134 includes, as elements for supporting and moving the pressing roller (square back processing roller) 123, a unit frame 147, roller pressurizing portions 138a and 138b, pressurizing springs 145a and 145b, an upper movement regulating portion 139, and a lower movement regulating portion 140. The pressing roller 123 is disposed such that the outer peripheral surface thereof is in contact with a downstream end surface of each of the lower clamp unit 120 and the upper clamp unit 121 as illustrated in FIGS. 5 and 10. In addition, a roller shaft 141 is disposed on the radially inner side of the pressing roller 123, and the pressing roller 123 is rotatable with respect to the roller shaft 141 as illustrated in FIG. 6B.

As illustrated in FIGS. 6A and 6B, the unit frame 147 includes a pair of side plates 147a disposed on the two sides of the pressing roller 123, a rear side plate 147b disposed on the left side of the downstream side (FIG. 6B) in the first conveyance direction of the pressing roller 123, and an upper side plate 147c and a lower side plate 147d that are provided on the two sides of the pressing roller 123 in the rotational axis direction so as to be bent from two end portions of the rear side plate 147b. The unit frame 147 is configured in this manner, and thus accommodates the pressing roller 123 in a space enclosed by the side plates and exposes the pressing roller 123 on the upstream side in the first conveyance direction.

In the present embodiment, the rear side plate 147b, the upper side plate 147c, and the lower side plate 147d are formed integrally, and has an approximate C shape in section view as illustrated in FIG. 6B. To be noted, these may be formed as separate members, or may be formed integrally with the pair of side plates 147a. The two end portions of the roller shaft 141 of the pressing roller 123 are respectively rotatably supported by the upper side plate 147c and the lower side plate 147d. In addition, the upper side plate 147c and the lower side plate 147d are provided to extend upstream of the pressing roller 123 in the first conveyance direction, and the upper movement regulating portion 139 and the lower movement regulating portion 140 are respectively supported at distal end portions of the upper side plate 147c and the lower side plate 147d.

That is, the upper movement regulating portion 139 is provided at a distal end portion of a support shaft 139a fixed to the upper side plate 147c and provided to extend downward from the upper side plate 147c. In addition, the lower movement regulating portion 140 is provided at a distal end portion of a support shaft 140a fixed to the lower side plate 147d and provided to extend upward from the lower side plate 147d. In addition, the upper movement regulating portion 139 is a roller rotatably provided at the distal end portion of the support shaft 139a, and the lower movement regulating portion 140 is a roller rotatably provided at the distal end portion of the support shaft 140a. To be noted, although two lower movement regulating portions 140 are provided side by side in the present embodiment, the number of the lower movement regulating portions 140 may be one. In addition, two upper movement regulating portions 139 may be also provided. The upper movement regulating portion 139 and the lower movement regulating portion 140 are positioned on the respective sides of the pressing roller 123 in the rotational axis direction of the roller shaft 141.

The roller pressurizing portions 138a and 138b are each coupled to the roller shaft 141 from the outside in the roller thickness direction of the pressing roller 123 and from the downstream side in the conveyance direction. Pressurizing springs 145a and 145b are disposed between the roller pressurizing portions 138a and 138b and the rear side plate 147b of the unit frame 147, and the roller shaft 141 is urged by the pressurizing springs 145a and 145b. The roller shaft 141 is configured to be movable in the conveyance direction, and therefore the pressurizing force by which the pressing roller 123 pressurizes the spine of the sheet bundle by the urging force of the pressurizing springs 145a and 145b changes in accordance with the change in the protruding amount of the spine of the sheet bundle from the lower clamp unit 120 and the upper clamp unit 121 that will be described later.

In addition, the pressing roller 123 is urged by the pressurizing springs 145a and 145b via the roller shaft 141, and is therefore pressurized by the lower clamp unit 120 and the upper clamp unit 121. In contrast, the upper movement regulating portion 139 and the lower movement regulating portion 140 are disposed on the opposite side to the pressing roller 123 across the lower clamp unit 120 and the upper clamp unit 121 so as to respectively oppose the lower clamp unit 120 and the upper clamp unit 121 (FIG. 5). That is, the upper movement regulating portion 139 and the lower movement regulating portion 140 are disposed on the upstream side of the lower clamp unit 120 and the upper clamp unit 121 in the conveyance direction of the sheet bundle (first conveyance direction) so as to respectively oppose the upper clamp unit 121 and the lower clamp unit 120.

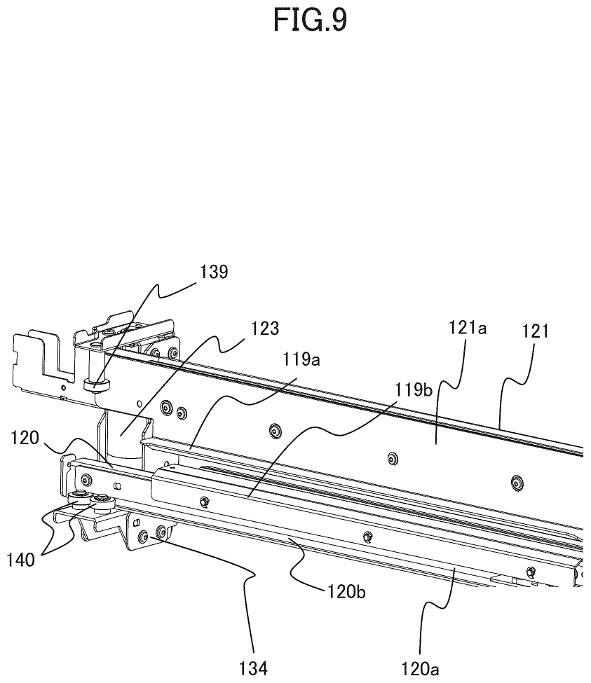

As illustrated in FIGS. 9 and 10, an end surface 120a on the upstream side of the lower clamp unit 120 is in contact with the lower movement regulating portion 140. In addition, an end surface 121a on the upstream side of the upper clamp unit 121 is in contact with the upper movement regulating portion 139. In the present embodiment, the lower movement regulating portion 140 and the upper movement regulating portion 139 are each a roller having a rotation shaft in a direction (up-down direction of FIG. 10, an approximately vertical direction in the present embodiment) orthogonal to the width direction of the sheet bundle and the conveyance direction of the sheet bundle, and respectively rotate in contact with the end surfaces 120a and 121a. As a result of this, upstream movement of the lower clamp unit 120 and the upper clamp unit 121 caused by the pressurizing force applied from the pressing roller 123 to the lower clamp unit 120 and the upper clamp unit 121 is restricted.

The conveyance amount of the sheet bundle conveyed by the saddle third roller pair 118 is counted by the square back process controller 345 when the leading end of the sheet bundle is detected by the saddle conveyance sensor 117 described above, and the sheet bundle is stopped after being conveyed by a predetermined conveyance amount. Specifically, as illustrated in FIG. 11A that will be described later, the sheet bundle is stopped in a state in which the spine of the sheet bundle subjected to the half-folding protrudes downstream in the conveyance direction more than the upper clamp unit 121 and the lower clamp unit 120. In the present embodiment, in the square back process, the conveyance amount of the sheet bundle by the saddle third roller pair 118 is controlled, and thus the protruding amount of the spine of the sheet bundle from the upper clamp unit 121 and the lower clamp unit 120 is adjusted.

### Upper Clamp unit and Lower Clamp unit

The upper clamp unit 121 moves from a receiving position (first position) for receiving the sheet bundle to a clamp holding position (second position) for holding the sheet bundle, thus the sheet bundle is pressurized between the upper clamp unit 121 and the lower clamp unit 120, and the sheet bundle is held by the upper clamping surface 142 and the lower clamping surface 143. At this time, the leading end of the sheet bundle protrudes by a predetermined protruding amount P1 from respective end surfaces 120c and 121b on the downstream side of the lower clamp unit 120 and the upper clamp unit 121 after the clamp holding in the conveyance direction as illustrated in FIG. 11B.

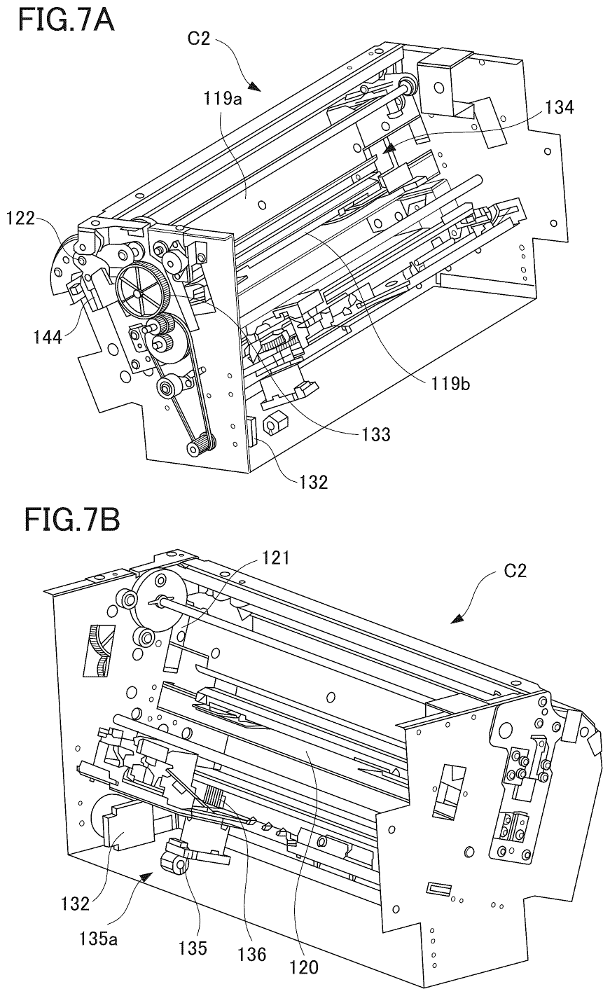

The upper clamp unit 121 operates by driving a clamp driving motor 132 (FIGS. 7A and 7B) by the square back process controller 345. As illustrated in FIGS. 7A and 7B, the square back processing portion C2 transmits a drive transmitted by a clamp driving train 133 constituted by a pulley, a belt, and a gear train further to a clamp driving link 122, and thus moves the upper clamp unit 121 connected to the clamp driving link 122 in the thickness direction of the sheet bundle. A plurality of clamp springs 144 that pressurize the sheet bundle are provided between the clamp driving link 122 and the upper clamp unit 121, and while the movement amount of the clamp driving link 122 remains constant, the contraction amount of the clamp spring 144 changes in accordance with the thickness of the sheet bundle, and thus the pressurizing force changes. The clamp holding position described above also changes in accordance with the thickness of the sheet bundle.

### Square Back Processing Portion

As illustrated in FIG. 11C that will be described later, the square back processing portion C performs the square back process on the sheet bundle held between the lower clamp unit 120 and the upper clamp unit 121 in a state of protruding from the end surfaces 120c and 121b by the predetermined protruding amount P1, by pressurizing the spine of the sheet bundle while moving, in the width direction of the sheet bundle in a scanning manner, the pressing roller 123 disposed on the downstream side in the conveyance direction.

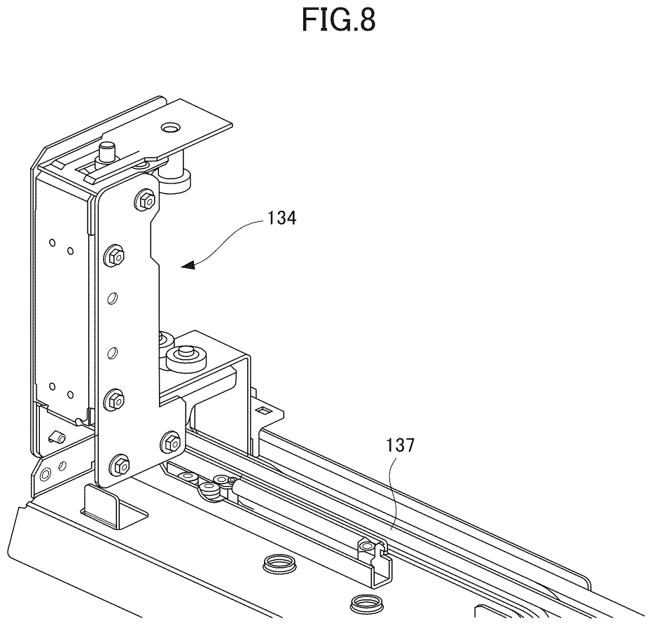

During the square back process, the pressing roller 123 is moved by operating a driving motor 135 (FIG. 7B) by the square back process controller 345. The pressing roller 123 is coupled to a driving belt 137 disposed in the width direction of the sheet bundle as illustrated in FIG. 8, and is movable in the width direction of the sheet bundle along a guide rail 120b illustrated in FIG. 9 that will be described later. The driving belt 137 rotates by receiving a driving force transmitted from the driving motor 135 via a driving train 136 (FIG. 7B) constituted by a gear train. As a result of this, the pressing roller 123 can be moved in a scanning manner in the width direction of the sheet bundle.

To be noted, the home position of the pressing roller 123 is provided on the front side and rear side of the sheet processing apparatus B. That is, after the square back process is performed on the first sheet bundle by moving the pressing roller 123 from the rear side to the front side, the square back process can be performed on the second sheet bundle by moving the pressing roller 123 from the front side to the rear side. An unillustrated sensor is provided at each home position of the pressing roller 123, and thus the position of the pressing roller 123 can be detected. To be noted, a configuration in which the home position is provided at only one of the front side and the rear side and the scanning movement of the pressing roller 123 in the width direction is performed only from the front side to the rear side or from the rear side to the front side may be employed. In the case where the home position is provided at only one of the front side and the rear side, for example, after performing the square back process on the first sheet bundle by moving the pressing roller 123 from the rear side to the front side, the pressing roller 123 may be returned from the front side to the rear side and the square back process may be performed also on the second sheet bundle by moving the pressing roller 123 from the rear side to the front side.

In addition, in one square back process, the pressing roller 123 is moved in one direction from the front side to the rear side or from the rear side to the front side, but the pressing roller 123 may be reciprocated in one square back process. For example, whether the pressing roller 123 is moved in one direction or reciprocated may be set in accordance with the number of sheets included in the sheet bundle or the type of the sheet. This setting may be automatically performed by the controller, or may be performed by an operator such as a user or a service worker. Further, whether the pressing roller 123 is moved in one direction or reciprocated may be arbitrarily settable by the operator in each square back process.

The lower clamp unit 120 includes the guide rail 120b formed along the width direction of the sheet bundle as illustrated in FIGS. 9 and 10. The lower movement regulating portion 140 moves along the guide rail 120b in engagement with the guide rail 120b when the pressing roller 123 moves in the width direction of the sheet bundle. The guide rail 120b is formed in an approximate C shape in section view by combining a plurality of members as illustrated in FIG. 10 such that part of the lower movement regulating portion 140 formed in a roller shape can enter the guide rail 120b. The lower surface of the radially outer side of the lower movement regulating portion 140 is engaged with the lower surface of the guide rail 120b, and the outer peripheral surface of the lower movement regulating portion 140 is in contact with the end surface 120a. As a result of this, the movement in the sheet bundle thickness direction is restricted when the pressing roller 123 moves. To be noted, the guide rail 120b may be a groove formed in one member provided on the upstream side of the lower clamp unit 120 in the conveyance direction.

After the square back process is completed, the pressing roller 123 is moved in the width direction and is thus retracted from the conveyance path of the sheet bundle by operating the driving motor 135 (FIG. 7B), and the upper clamp unit 121 is moved in a direction away from the sheet bundle (FIG. 11D that will be described later) by operating the clamp driving motor 132 (FIGS. 7A and 7B). As a result of this, the sheet bundle can be further conveyed downstream. To be noted, the sheet bundle can be also discharged without performing the square back process described above.

### Discharge Portion

As illustrated in FIG. 2, the sheet bundle having passed the saddle portion B2 is conveyed toward the saddle discharge guide 124 disposed further downstream of the pressing roller 123 in the first conveyance direction, by the saddle third roller pair 118. The saddle discharge guide 124 is supported to be swingable about a first fulcrum 124b including a rotation shaft parallel to the rotational axis of each roller of the saddle third roller pair 118. The first fulcrum 124b is positioned above an extension line of the conveyance direction (first conveyance direction, saddle third roller conveyance direction 118c) of the sheet bundle by the saddle third roller pair 118. Further, the saddle discharge guide 124 is disposed to hang down in the vertical direction from the first fulcrum 124b.

In addition, the saddle discharge guide 124 is formed such that the side surface thereof on the upstream side in the first conveyance direction is inclined upstream in the first conveyance direction from the first fulcrum 124b toward a middle portion 124a in the vertical direction. In addition, the side surface of the saddle discharge guide 124 on the upstream side in the first conveyance direction is inclined downstream in the first conveyance direction from the middle portion 124a toward the lower end in the vertical direction. That is, the side surface of the saddle discharge guide 124 on the upstream side in the first conveyance direction is formed such that the middle portion 124a in the vertical direction protrudes upstream in the first conveyance direction as compared with the other part. Further, in the side surface of the saddle discharge guide 124 on the upstream side in the first conveyance direction, a guide surface 124d is provided in a portion from the middle portion 124a to the lower end.

The guide surface 124d is positioned below an extension line obtained of the saddle third roller conveyance direction 118c, comes into contact with the sheet bundle conveyed by the saddle third roller pair 118, and guides the sheet bundle downward. The saddle discharge guide 124 is capable of pivoting about the first fulcrum 124b when the sheet bundle comes into contact with the guide surface 124d. To be noted, depending on the stiffness of the sheet bundle, there is a case where the sheet bundle does not come into contact with the guide surface 124d of the saddle discharge guide 124, and even in the case where the contact occurs, since the amount of the pivot changes depending on the stiffness, the saddle discharge guide 124 does not necessarily pivot.

In addition, a second fulcrum 124c is provided at a lower end portion of the saddle discharge guide 124, and a saddle discharge roller 125 that will be described later is coupled to the lower end portion of the saddle discharge guide 124 so as to be pivotable about the second fulcrum 124c. The second fulcrum 124c is positioned below the guide surface 124d, and includes a pivot shaft parallel to the pivot shaft of the first fulcrum 124b.

When the sheet bundle continues to be conveyed by the saddle third roller pair 118, the sheet bundle is passed onto a saddle discharge unit 131 disposed downstream of the square back processing unit 134 in the first conveyance direction and below the saddle discharge guide 124 in the vertical direction. The saddle discharge unit 131 includes a saddle discharge upstream belt 127, a saddle discharge upstream sensor 128, a saddle discharge downstream belt 129, and a saddle discharge downstream sensor 130.

The saddle discharge upstream belt 127 is positioned below the guide surface 124d of the saddle discharge guide 124, and guides and conveys the sheet bundle guided downward by the guide surface 124d further downstream. The saddle discharge upstream belt 127 is inclined downward in the vertical direction toward the downstream side in the conveyance direction. The saddle discharge downstream belt 129 serving as a sheet bundle discharge portion receives the sheet bundle conveyed from the saddle discharge upstream belt 127, and further guides and conveys the received sheet bundle downstream. The saddle discharge downstream belt 129 is inclined upward in the vertical direction toward the downstream side in the conveyance direction. Therefore, the sheet bundle guided to the saddle discharge upstream belt 127 by the guide surface 124d is conveyed by the saddle discharge upstream belt 127 in a direction inclined downward in the vertical direction, and is then conveyed by the saddle discharge downstream belt 129 in a direction inclined upward in the vertical direction.

In addition, the saddle discharge upstream sensor 128 that detects the sheet bundle on the upstream side is disposed on the upstream side in a conveyable region of the saddle discharge upstream belt 127, and the saddle discharge downstream sensor 130 that detects the sheet bundle on the downstream side is disposed on the upstream side in a conveyable region of the saddle discharge downstream belt 129.

The sheet bundle passed on to the saddle discharge unit 131 is guided and conveyed by the saddle discharge upstream belt 127 and the saddle discharge downstream belt 129, and is then stacked. The saddle discharge upstream belt 127 nips the sheet bundle at a nip point between the saddle discharge upstream belt 127 and the saddle discharge roller 125 described above on the downstream side in the conveyance direction. The sheet bundle present on the saddle discharge upstream belt 127 is configured to suppress opening on the opening portion side (fore edge side) at this nip point. The position of this nip point can change about a second fulcrum 124c in accordance with the thickness of the sheet bundle.

While the succeeding sheet bundle is processed, the preceding sheet bundle is conveyed upstream in the conveyance direction by the saddle discharge upstream belt 127, and is stopped after a predetermined conveyance amount since being detected by the saddle discharge upstream sensor 128 or the saddle discharge downstream sensor 130. The position where the preceding sheet bundle stops corresponds to a position where the opening on the opening portion side of the preceding sheet bundle can be suppressed at the nip point between the saddle discharge upstream belt 127 and the saddle discharge roller 125, and to a position where the succeeding sheet comes into contact with the upper surface of the preceding sheet bundle when being discharged. That is, in the present embodiment, the succeeding sheet bundle is stacked on the preceding sheet bundle such that the sheet bundles partially overlap each other in the saddle discharge unit 131.

As described above, the saddle discharge unit 131 discharges the succeeding sheet bundle onto the upper surface of the preceding sheet bundle without entering the opening portion of the preceding sheet bundle, and thus the sheet bundles are stably stacked without occurrence of a failure such as getting caught by the preceding sheet bundle, getting curled against the preceding sheet bundle, or pushing out the preceding sheet bundle. That is, by appropriately changing the conveyance amount described above in accordance with the size of the sheet bundle, the succeeding sheet bundle can be stably stacked on the preceding sheet bundle.

The saddle discharge portion 126 is disposed at a position downstream of the saddle discharge guide 124 in the first conveyance direction and between the saddle discharge upstream belt 127 and the saddle discharge downstream belt 129. The sheet bundle conveyed to the saddle discharge unit 131 passes through the saddle discharge portion 126 to be discharged to the outside of the sheet processing apparatus B, and thus the user can easily access the discharged sheet bundle.

To be noted, in the case where another apparatus is present on the downstream side of the saddle discharge unit 131, the sheet bundle can be passed on to the downstream apparatus by continuing the conveyance without the stacking. In addition, in the present embodiment, a discharge cover 151 serving as a cover member is provided on the outside of the saddle discharge portion 126. The discharge cover 151 is disposed so as not to interrupt discharge of the sheet bundle from the saddle discharge portion 126 and such that an operator such as a user cannot access the inside of the apparatus through the saddle discharge portion 126.

### Control of Square Back Process

Next, the control of the square back process of the present embodiment will be described with reference to FIGS. 11A to 11D. As described above, the square back processing portion C2 performs the square back process of forming a corner on the spine of the sheet bundle subjected to the saddle binding process and the half-folding process. A square back processing mode that is a control mode for performing the square back process will be described below. In addition, the half-folding controller 344 illustrated in FIG. 3 controls each conveyance roller pair of the folding roller pair 113, the saddle second roller pair 115, and the saddle third roller pair 118 by the same driving.

The square back processing mode will be described. The square back processing mode is a mode in which a corner is formed on the spine of a sheet bundle Sb by pressing the pressing roller 123 against the spine of the sheet bundle Sb. The half-folding controller 344 conveys the sheet bundle Sb subjected to the half-folding to the gap between the upper clamp unit 121 and the lower clamp unit 120 in the separated state in response to detection of the leading end of the sheet bundle Sb by the saddle conveyance sensor 117. Then, as illustrated in FIG. 11A, the half-folding controller 344 stops the conveyance of the sheet bundle Sb in a state in which a spine Ssp of the sheet bundle Sb protrudes further downstream in the first conveyance direction than the end surfaces 121b and 120c on the downstream side in the first conveyance direction of the upper clamp unit 121 and the lower clamp unit 120.

In this state, the square back process controller 345 drives the clamp driving motor 132 (FIGS. 7A and 7B) and thus moves the upper clamp unit 121 toward the lower clamp unit 120, and as illustrated in FIG. 11B, the sheet bundle Sb is nipped by the upper clamp unit 121 and the lower clamp unit 120. At this time, the spine Ssp of the sheet bundle Sb protrudes further downstream than the end surfaces 121b and 120c on the downstream side in the first conveyance direction of the upper clamp unit 121 and the lower clamp unit 120 by P1.

Next, the square back process controller 345 operates the driving motor 135 (FIG. 7B), and thus moves the pressing roller 123 in the width direction of the sheet bundle Sb. At this time, as illustrated in FIG. 11C, the pressing roller 123 moves in the width direction while pressurizing the spine Ssp of the sheet bundle Sb, and thus the square back process is performed on the spine Ssp of the sheet bundle Sb. Then, as illustrated in FIG. 11D, the square back process controller 345 drives the clamp driving motor 132 (FIGS. 7A and 7B), thus separates the upper clamp unit 121 from the lower clamp unit 120, and releases the nipping of the sheet bundle Sb. In the first mode, the square back process is finished here, and the discharge operation of the sheet bundle Sb described above is performed.

### Draw-Out of Saddle Portion B2

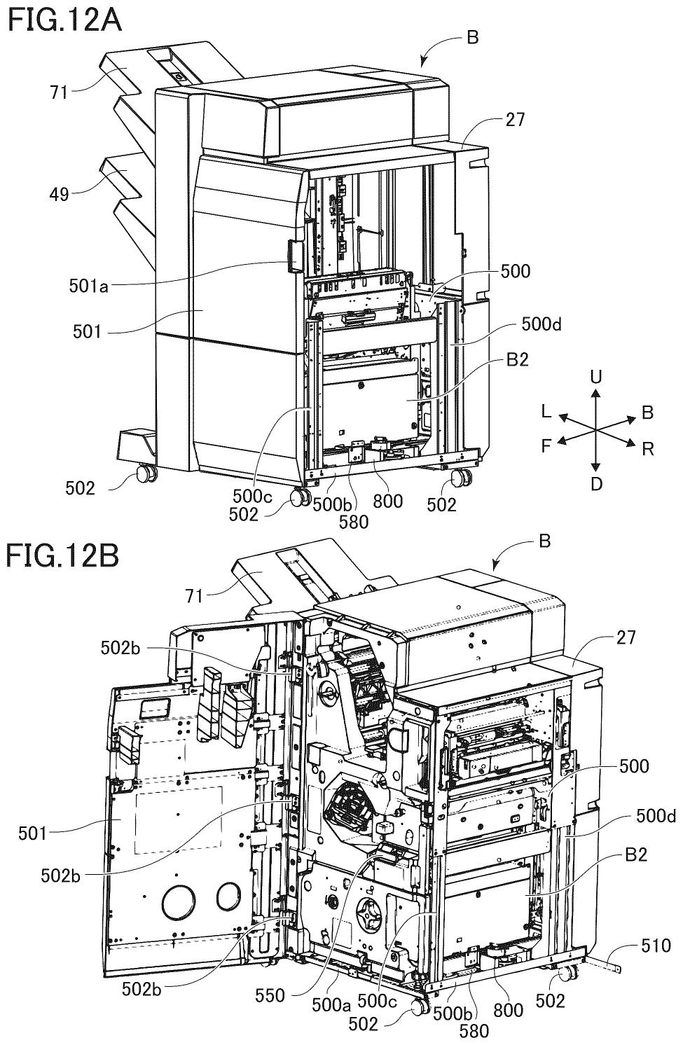

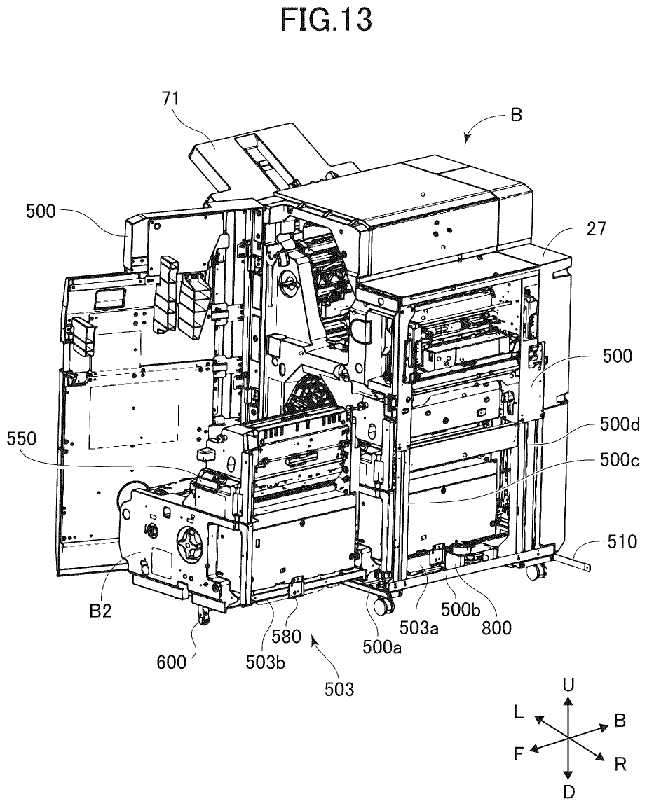

Next, an operation performed when performing maintenance of the saddle portion B2 serving as a processing unit will be described with reference to FIGS. 12A to 13. Examples of the maintenance mentioned herein include a case where a conveyance abnormality of the sheet has occurred and the user performs jam removal of removing the sheet in the unit, a case where the user or a service worker replaces a part, and the like. FIGS. 12A to 13 are each a perspective view of the sheet processing apparatus B as viewed from the side (upstream side in the sheet conveyance direction) on which the sheet processing apparatus B is coupled to the image forming apparatus A. FIG. 12A illustrates a state in which a front cover 501 of the sheet processing apparatus B is closed, FIG. 12B illustrates a state in which the front cover 501 of the sheet processing apparatus B is open, and FIG. 13 illustrates a state in which the saddle portion B2 of the sheet processing apparatus B has been drawn out.

The saddle portion B2 is disposed to be capable of being drawn out from the housing 27 serving as a casing and being inserted to an attached position in the housing 27. In the present embodiment, the saddle portion B2 is configured to be drawn out from the front side (F side) in the front-rear direction (F-B direction) that is a direction orthogonal to the sheet conveyance direction in the sheet processing apparatus B. To be noted, in the description below, a sheet conveyance direction (may be simply referred to as a “conveyance direction”) refers to a conveyance direction of the sheet in the conveyance path 28 (left-right direction in FIG. 2). In addition, as indicated by the coordinate axes of FIG. 12A, the U side is the upper side in the vertical direction, and the D side is the lower side in the vertical direction. In addition, the F side is the front side of the sheet processing apparatus B, and the B side is the back side (also referred to as the rear side) of the sheet processing apparatus B. Further, the L side is the left side of the sheet processing apparatus B as viewed from the front side, and is the downstream side in the sheet conveyance direction. The R side is the right side of the sheet processing apparatus B as viewed from the front side, and is the upstream side in the sheet conveyance direction.

The sheet processing apparatus B is provided with the front cover 501 (opening/closing door) constituting part of the exterior of the apparatus. The housing 27 serving as a casing includes a body frame 500, the front cover 501, and other exterior covers and the like. Casters 502 are respectively provided at four positions on the lower surface of the body frame 500. The four casters 502 serving as main support portions support the housing 27 with respect to the installation surface. As a result of providing the casters 502 in this manner, the sheet processing apparatus B can be easily moved by the user or the service worker when installing the sheet processing apparatus B at a desired position.

To be noted, the sheet processing apparatus B is fixed to the image forming apparatus Aby a coupling portion 510 (FIGS. 12B and 13) provided on the body frame 500 when connected to the image forming apparatus A. In addition, the sheet processing apparatus B and the image forming apparatus A are also coupled by engagement between engagement members such as pins and hooks provided in the vicinity of a sheet discharge port of the image forming apparatus A and the vicinity of a sheet inlet port of the sheet processing apparatus B. To be noted, the connection configuration between the sheet processing apparatus B and the image forming apparatus A may be either of the fixation using the coupling portion 510 and engagement between engagement members, or a different connection configuration may be employed.

The front cover 501 is provided with a handle 501a at an end portion on the R side as illustrated in FIG. 12A. In addition, the front cover 501 is pivotably supported with respect to the body frame 500 as illustrated in FIG. 12B, at three positions via hinges 502b in the illustrated example. The rotational axis direction of the hinges 502b is the vertical direction, and the end portion of the front cover 501 on the L side is pivotably supported about the rotational axis of the hinges 502b. In the case of performing the maintenance of the saddle portion B2, the user or the service worker first hooks the hand on the handle 501a of the front cover 501 in the state of FIG. 12A and pulls to the F side, and thus opens the front cover 501 from the R side to the L side. At this time, the front cover 501 pivots about the hinges 502b, and an operation lever 550 to be operated when drawing out the saddle portion B2 is exposed as illustrated in FIG. 12B. To be noted, the direction in which the front cover 501 is opened may be reversed from that described above. In addition, the front cover 501 may be formed in a double door form.

When the operation lever 550 is operated by the user or the service worker, an unillustrated lock between the saddle portion B2 and the body frame 500 is released, and it becomes possible to draw out the saddle portion B2 from the inside of the housing 27 to the F side (front side) as illustrated in FIG. 13. To be noted, by pushing the drawn-out saddle portion B2 to the B side (rear side), the saddle portion B2 is inserted into the housing 27 to the attached position, and thus the saddle portion B2 is locked with respect to the body frame 500 by an unillustrated lock portion.

The saddle portion B2 is supported with respect to the body frame 500 via a rail portion 503. The rail portion 503 guides the saddle portion B2 such that the saddle portion B2 can be drawn out from and inserted into the inside body frame 500 of the housing 27. The rail portion 503 configured in this manner includes a fixed rail 503a fixed to the body frame 500, and a slide rail 503b slidable in the F-B direction (front-rear direction) with respect to the fixed rail 503a. Although the rail portion 503 supporting the R side of the saddle portion B2 is illustrated in FIG. 13, a similar rail portion 503 is also disposed on the L side. The rail portions 503 configured in this manner guide the saddle portion B2 such that the saddle portion B2 can be drawn out from and inserted into the inside of the housing 27. That is, the saddle portion B2 is supported by and fixed to the slide rails 503b, and can be drawn out from and inserted into the body frame 500 of the housing 27 as a result of the slide rails 503b sliding in the F-B direction with respect to the fixed rails 503a.

As illustrated in FIG. 12B, the saddle portion B2 is positioned at the attached position (accommodated position) in a state in which the saddle portion B2 is positioned inside the body frame 500. In contrast, as illustrated in FIG. 13, a position in which the saddle portion B2 is outside the housing 27 is a drawn-out position of the saddle portion B2, which serves as a maintenance position where a sheet is removed in the case where a jam of sheet has occurred in the saddle portion B2, or where part is replaced.

To be noted, the attached position of FIG. 12B does not have to be a position where all the elements constituting the saddle portion B2 are inside the body frame 500 including struts thereof as long as the front cover 501 can be closed. For example, a state in which part of the operation lever 550, a cover member, or the like projects more to the front side than the body frame 500 is acceptable, and in this case, for example, the part projecting to the front side of the body frame 500 is positioned within a recess portion or the like formed inside the front cover 501.

In addition, the drawn-out position illustrated in FIG. 13 does not have to be a position where all the elements constituting the saddle portion B2 are outside the body frame 500 as long as the user or the service worker can access the saddle portion B2. For example, parts of the saddle portion B2 disposed on the B side such as cables and various driving mechanisms may be positioned inside the body frame 500.

In addition, the drawn-out position may be configured as two positions including a maintenance position for the user to perform jam removal and a maintenance position for the service worker to perform maintenance of each unit or the like. For example, the saddle portion B2 may be configured to be capable of being further drawn out to the F side such that the service worker can also access electric parts disposed on the B side (rear side) of the apparatus. As a result of this, no unnecessary draw-out and insertion operation of the saddle portion B2 occurs at the time of maintenance by the user, and the service worker can easily perform the work at the time of maintenance by the service worker, which improves the usability of the apparatus. For example, a configuration in which the slide rail 503b can be drawn out to two positions with respect to the fixed rail 503a and the saddle portion B2 is drawn out further than the position of FIG. 13 (maintenance position for the user) at the time of maintenance by the service worker is employed.

In addition, although the rail portion 503 is provided on the lower side of the saddle portion B2 in the present embodiment, the rail portion 503 supporting the saddle portion B2 may be provided at a different position as long as the maintenance is not interrupted. For example, the rail portion 503 that guides the saddle portion B2 may be provided on the upper side. To be noted, the support stiffness of the rail portion 503 for supporting the saddle portion B2, which is a heavy object, is more easily secured in the case where the rail portion 503 is provided on the lower side than in the case where the rail portion 503 is provided on the upper side. In addition, in the present embodiment, part of a saddle stacking tray 150 on which a sheet from the saddle path 32 is conveyed projects at the upper portion of the saddle portion B2 (see FIG. 2). Therefore, the width of the saddle portion B2 in the L-R direction (left-right direction) is smaller at the upper portion than at the lower portion, it is more difficult to dispose the rail portion 503 on the upper side of the saddle portion B2, and even if the rail portion 503 is disposed on the upper side, it is difficult to perform jam removal at the upper portion of the saddle portion B2. In contrast, in the case where the rail portion 503 is disposed on the lower side of the saddle portion B2 as in the present embodiment, the saddle portion B2 can be easily accessed from above, and therefore the jam having occurred in the saddle portion B2 can be easily removed.

Here, as described above, when the saddle portion B2 is drawn out to the F side with respect to the body frame 500, the position of the center of gravity of the sheet processing apparatus B is displaced to the F side as compared with a state in which the saddle portion B2 is attached to the inside of the body frame 500. Therefore, there is a possibility that the apparatus is inclined to the front side when the saddle portion B2 is drawn out more. In the case where the saddle portion B2 is heavy, a larger load acts on the on the rail portion 503, which can cause deformation of the body frame 500 and the like. Therefore, in the present embodiment, a support leg portion 600 serving as a support portion that supports the saddle portion B2 is provided to suppress inclination of the apparatus at the time of drawing out the saddle portion B2. In the present embodiment, the support leg portion 600 is configured to function as a support portion that supports the saddle portion B2 only when the saddle portion B2 is drawn out by an unillustrated mechanism.

As described above, after the maintenance by the user or the service worker is finished in a state in which the saddle portion B2 has been drawn out, the user or the service worker inserts the saddle portion B2 to the attached position inside the housing 27. In the case where the saddle portion B2 is returned at a high speed during the insertion operation (returning operation) of the saddle portion B2, there is a possibility that the saddle portion B2 collides with the body frame 500 of the housing 27, and the body frame 500 is deformed or part in the apparatus is damaged. In addition, there is a possibility that, when the saddle portion B2 collides with the body frame 500, the coupling portion 510 between the sheet processing apparatus B and the image forming apparatus A described above is deformed, or the engagement between the engagement members provided in the vicinity of the sheet discharge port of the image forming apparatus A and in the vicinity of the sheet inlet port of the sheet processing apparatus B is displaced. In this case, as a result of the positions of the image forming apparatus A and the sheet processing apparatus B being displaced, the sheet is conveyed from the image forming apparatus A to the sheet processing apparatus B in a skewed state. Further, there is a possibility that the positions between the apparatuses are deviated from each other as a result of the deformation of the coupling portion 510 between the image forming apparatus A and the sheet processing apparatus B.

Particularly, the saddle portion B2 of the present embodiment includes the half-folding processing mechanism C1 and the square back processing portion C2, and is therefore the heaviest unit in the sheet processing apparatus B. Therefore, the speed of the saddle portion B2 is likely to be high when returning the saddle portion B2 into the body frame 500 from the drawn-out state, and the impact of collision with the body frame 500 is likely to be large.

Therefore, in the present embodiment, a braking device 800 serving as a regulating unit for regulating the movement of the saddle portion B2 when the saddle portion B2 is inserted into the body frame 500 at a high speed is provided. The braking device 800 is provided on the body frame 500 side, and reduces the movement speed of the saddle portion B2 by abutting an abutting portion 580 (FIG. 13) fixed to the saddle portion B2 in the case where the saddle portion B2 is returned to the attached position at a high speed.

### Braking Device

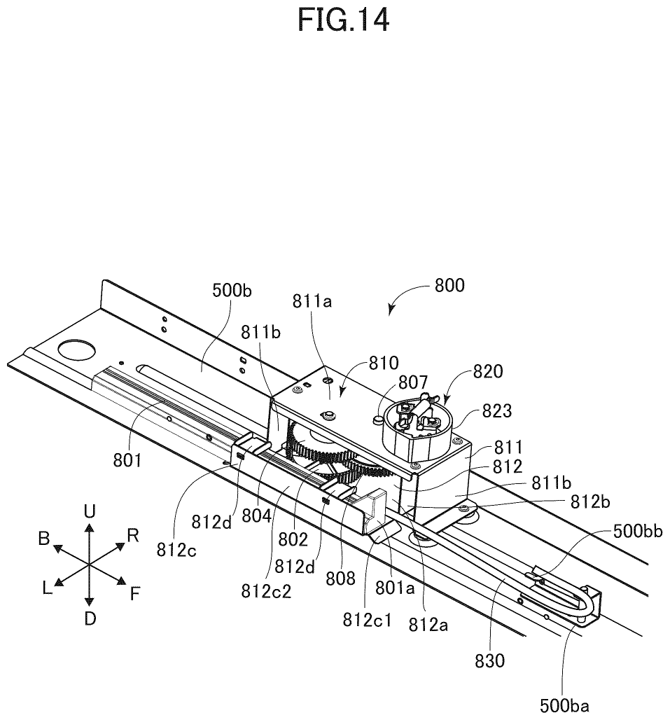

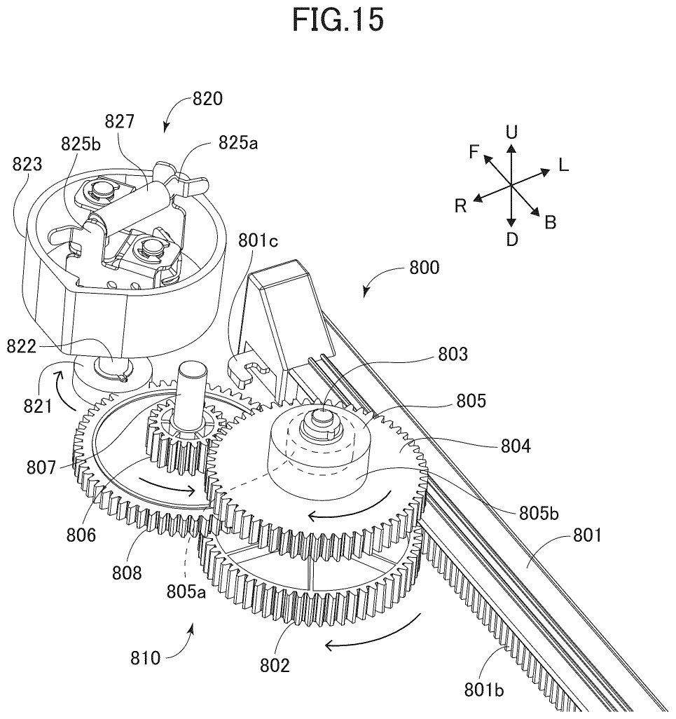

The details of the braking device 800 configured in this manner will be described with reference to FIGS. 14 and 15. FIG. 14 is a perspective view illustrating a state in which the braking device 800 is fixed to a right lower stay 500b of the body frame 500 serving as a fixed portion. FIG. 15 is a perspective view of the braking device 800 as viewed from the B side in which the right lower stay 500b is omitted.

Here, the body frame 500 includes a bottom frame including a front lower stay 500a and a right lower stay 500b, a right front strut 500c, a rear side plate 500d, and the like as illustrated in FIG. 13. The processing portion B1, an unillustrated control board, and the like are fixed to respective metal plates constituting the body frame 500. The four casters 502 are fixed to the bottom frame including a front lower stay 500a and the right lower stay 500b.

The braking device 800 restricts the movement of the saddle portion B2 in the insertion direction in the case where the saddle portion B2 is inserted into the housing 27 at a speed equal to or higher than a predetermined speed, and allows the movement of the saddle portion B2 in the insertion direction in the case where the saddle portion B2 is inserted into the housing 27 at a speed lower than the predetermined speed. The braking device 800 configured in this manner is fixed to the right lower stay 500b of the body frame 500. In addition, the braking device 800 includes an abutting surface 801a that abuts the abutting portion 580 (FIG. 13) fixed to the saddle portion B2, a rack 801 including a rack gear portion 801b, a gear unit 810 including a gear 802 that engages with the rack 801, and a centrifugal brake unit 820.

### Gear Unit

The gear unit 810 serving as a damper mechanism will be described in detail. The gear unit 810 applies a load to the saddle portion B2 moving in a direction from the drawn-out position toward the attached position (accommodated position), and thus absorbs the impact imposed on the centrifugal brake unit 820 in the case where the centrifugal brake unit 820 brakes the saddle portion B2 as will be described later. The gear unit 810 includes the rack 801 and the gear 802, as described above, and further includes a plurality of gears 804, 806, and 808, and a transmission member 805. The rack 801 is disposed to be slidable in the F-B direction with respect to the right lower stay 500b of the body frame 500, and the F-side end surface of the rack 801 serves as the abutting surface 801a described above. In addition, the rack gear portion 801b is formed on a side surface of the rack 801.

The gear 802 serving as a first gear is disposed at a position adjacent to the rack 801, engages with the rack gear portion 801b, and rotates in accordance with the slide movement of the rack 801. That is, the gear 802 rotates by receiving a driving force input by the movement of the saddle portion B2 in a direction from the drawn-out position toward the attached position. The gear 804 serving as a second gear is supported by a rotation shaft 803 shared with the gear 802, and integrally rotates with the gear 802 in accordance with the rotation of the gear 802. The gear 806 engages with the gear 804, and the rotation of the gear 804 is transmitted thereto. The gear 808 is provided on a rotation shaft 807 shared with the gear 806, and integrally rotates with the gear 806. The gear 808 has a large diameter than and more teeth than the gear 806. In addition, the gear 808 engages with a gear 821 fixed to a rotation shaft 822 of the centrifugal brake unit 820 that will be described later, and transmits rotation to the gear 821. In the present embodiment, the gear unit 810 is configured to accelerate the rotation input from the rack 801 to the gear 802 and transmit the accelerated rotation to the rotation shaft 822.

The rotation shaft 803 and the rotation shaft 807 are rotatably supported by a first fixed metal plate 811 and a second fixed metal plate 812 as illustrated in FIG. 14. The first fixed metal plate 811 and the second fixed metal plate 812 are each formed to have an approximate C shape in section view by bending a metal plate, and are disposed to sandwich the gears 802, 804, 806, and 808 described above from the upper side and the lower side. Further, the two end portions of each of the rotation shafts 803 and 807 of the gears are respectively rotatably supported by a fixed plate portion 811a of the first fixed metal plate 811 and a fixed plate portion 812a of the second fixed metal plate 812. A bent plate portion 811b bent downward is provided at each end portion in the F-B direction of the fixed plate portion 811a of the first fixed metal plate 811 covering the upper side of each gear. Further, the bent plate portion 811b is fixed to the right lower stay 500b by using screws or the like.

In contrast, a bent plate portion 812b bent upward is provided at each end portion in the F-B direction of the fixed plate portion 812a of the second fixed metal plate 812. The bent plate portions 812b are fixed to the first fixed metal plate 811 by using screws or the like. In addition, the fixed plate portion 812a includes an extension portion 812c extended toward the rack 801 side. The extension portion 812c includes a support plate portion 812c1 that supports the rack 801 from the lower side, and first restricting plate portions 812c2 formed to protrude upward at positions on respective sides in the direction orthogonal to the slide direction of the rack 801, that is, in the L-R direction. In addition, second restriction plate portions 812d disposed to sandwich the rack 801 between the second restricting plate portions 812d and the support plate portion 812c1 are fixed to the upper end portions of the first restricting plate portions 812c2.

Therefore, the movement of the rack 801 in the L-R direction is restricted by the pair of first restricting plate portions 812c2, and the movement of the rack 801 in the up-down direction (U-D) direction is restricted between the second restricting plate portions 812d and the support plate portion 812c1. Therefore, the rack 801 is slidable in the F-B direction in a state in which the movement thereof in the L-R direction and the U-D direction with respect to the second fixed metal plate 812 is restricted. Particularly, on the rack 801, a force acts in a direction away from the gear 802 due to a reaction force from the engagement with the gear 802. Therefore, the movement of the rack 801 in this direction is restricted by the first restricting plate portion 812c2 disposed on the opposite side to the gear 802. In addition, although illustration is omitted from FIG. 14, the first restricting plate portion 812c2 on the gear 802 side opposes the rack 801 on both sides in the F-B direction across a position where the rack gear portion 801b of the rack 801 engages with the gear 802 such that these gears can engage with each other.

Further, other elements may be added to restrict the movement of the rack 801 in the L-R direction. For example, a groove extending in the B-F direction may be formed on the lower surface of the rack 801, and a plurality of shafts fit in the groove with play therebetween may be provided. In this case, the plurality of shafts may be fixed to the second fixed metal plate 812. The movement of the rack 801 in the L-R direction can be restricted more by setting the play between the groove of the rack 801 and the plurality of shafts fixed to the second fixed metal plate 812 to be smaller.

As described above, each gear and the rack 801 are fixed to or supported by the first fixed metal plate 811 and the second fixed metal plate 812, and are each fixed to the right lower stay 500b via the first fixed metal plate 811 and the second fixed metal plate 812. To be noted, the centrifugal brake unit 820 that will be described later is also fixed to the first fixed metal plate 811 as illustrated in FIG. 14. Therefore, the braking device 800 including the gear unit 810 and the centrifugal brake unit 820 can be fixed to the right lower stay 500b in a state in which these units are assembled as one unit. Therefore, it is easy to mount the braking device 800 on the body frame 500.

In addition, as illustrated in FIG. 14, the rack 801 is urged toward the F side by a spring 830. The spring 830 is hooked on a hook 801c (FIG. 15) provided on the rack 801 and a hook 500bb of a fixed metal plate 500ba fixed to the right lower stay 500b. The fixed metal plate 500ba is disposed more on the F side than the movement range of the rack 801, and the rack 801 is urged toward the F side, that is, in a direction from the rear side toward the front side of the sheet processing apparatus B, by hooking the spring 830 on the hook 500bb provided on the fixed metal plate 500ba and the hook 801c of the rack 801.

Therefore, as will be described above, in the case where the saddle portion B2 is inserted toward the B side toward the attached position and the abutting portion 580 (FIG. 13) of the saddle portion B2 abuts the abutting surface 801a, the rack 801 moves toward the B side together with the saddle portion B2 against the urging force of the spring 830. In contrast, in the case where the saddle portion B2 is drawn out toward the F side, the rack 801 moves toward the F side by the urging force of the spring 830. To be noted, when the abutting portion 580 moves away from the abutting surface 801a due to the movement of the saddle portion B2 in the draw-out direction, the movement of the rack 801 toward the F side is restricted by an unillustrated restricting portion. This restricting position is set to a position where the abutting portion 580 abuts the abutting surface 801a before the saddle portion B2 reaches the attached position when the saddle portion B2 is inserted toward the attached position, and where the abutting portion 580 abuts the abutting surface 801a at an appropriate timing.

The gear unit 810 described above includes a transmission member 805 serving as a one-direction rotation transmission portion as illustrated in FIG. 15. The transmission member 805 includes a load application portion 805a that applies a load of a predetermined torque to the rotation shaft 803 when rotating in one direction, and a fixed member 805b fixed to the gear 804 via the load application portion 805a. The transmission member 805 transmits rotation to the rotation shaft 822 of the centrifugal brake unit 820 in the case where the saddle portion B2 is moved in the insertion direction (B direction), and does not transmit rotation from the rotation shaft 822 (that is, idles) in the case where the saddle portion B2 moves in the draw-out direction (F direction). Particularly, in the case where the rack 801 moves in the B direction, the load application portion 805a applies a load of a predetermined torque to the rotation shaft 803, thus the fixed member 805b integrally rotates with the rotation shaft 803, and thus the transmission member 805 transmits the rotational driving of the rotation shaft 803 to the gear 804.

In the present embodiment, the transmission member 805 is provided on the rotation shaft 803 of the gears 802 and 804, but the transmission member 805 may be provided on any one the rotation transmission members in a range from the rack 801 to the rotation shaft 822. To be noted, it is preferable that the transmission member 805 is provided on the rotation shaft 803 that is at the position closest to the rack 801 in the rotation transmission direction. This is because in the case where the transmission member 805 is provided at this position, the rotation is not transmitted to a gear train downstream thereof when the transmission member 805 idles, and thus the rotational load can be reduced. To be noted, although a one-way hinge manufactured by Origin Co., Ltd. is used as the transmission member 805 in the present embodiment, a different element may be used as long as that element idles in the case where the rotation shaft 803 is rotated in one direction, and integrally rotates with the gear 804 while applying a predetermined rotational load to the rotation shaft 803 in the case where the rotation shaft 803 is rotated in another direction.

As described above, as a result of providing the transmission member 805 on the rotation shaft 803, when the saddle portion B2 is inserted in a direction from the drawn-out position toward the attached position and the rack 801 moves toward the F side, the gears 802 and 804 integrally rotate with the rotation shaft 803, and transmit the rotation to the rotation shaft 822 through the gears 806, 808, and 821 as indicated by an arrow in FIG. 15. At this time, the gears 806, 808, and 821 rotate in the direction indicated by an arrow in FIG. 15. In contrast, when the saddle portion B2 is drawn out from the attached position toward the drawn-out position and the rack 801 moves toward the B side, the gear 802 rotates in a direction opposite to the arrow of FIG. 15. At this time, the transmission member 805 idles, thus the transmission of rotation to the gear 804 is blocked, and therefore the gears 806, 808, and 821 do not rotate.

### Centrifugal Brake Unit

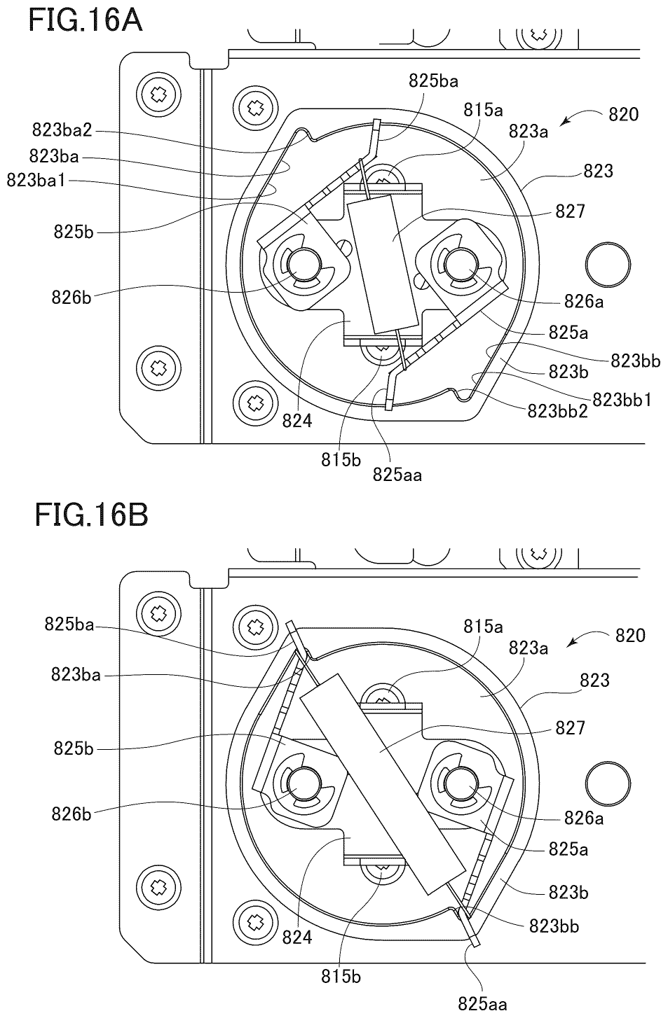

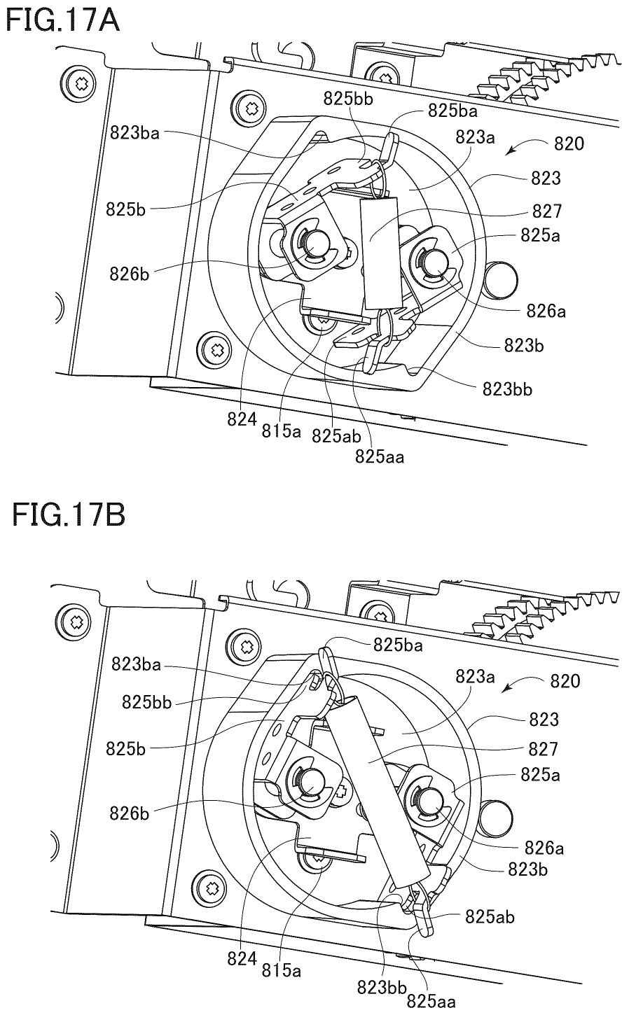

Next, the centrifugal brake unit 820 serving as a braking mechanism will be described with reference to FIGS. 16A to 17B in addition to FIGS. 14 and 15 described above. FIGS. 16A and 17A are respectively a plan view and a perspective view of the centrifugal brake unit 820 in a state in which the brake is not acting. FIGS. 16B and 17B are respectively a plan view and a perspective view of the centrifugal brake unit 820 in a state in which the brake is acting.

The centrifugal brake unit 820 acts and brakes the saddle portion B2 in the case where the saddle portion B2 is inserted in a direction from the drawn-out position toward the attached position at a speed equal to or higher than a predetermined speed. The centrifugal brake unit 820 includes a gear 821, a rotation shaft 822, an engagement member 823, a rotary metal plate 824, a pair of engagement metal plates (first engagement metal plate and second engagement metal plate) 825a and 825b, rotation shafts 826a and 826b, and a spring 827. The gear 821 engages with the gear 808 of the gear unit 810, and thus rotation is transmitted thereto from the gear 808. The rotation shaft 822 integrally rotates with the gear 821.

The engagement member 823 is a cylindrical member fixed to the first fixed metal plate 811 of the gear unit 810 as illustrated in FIG. 14. In the present embodiment, the engagement member 823 is fixed to an upper surface, that is, a surface of the fixed plate portion 811a of the first fixed metal plate 811 on the side opposite to the side on which the gear train of the gear unit 810 including the gear 821 is disposed. That is, the engagement member 823 includes a bottom surface 823a and a wall portion 823b, and as illustrated in FIGS. 16A and 16B, the bottom surface 823a is fixed to the first fixed metal plate 811 via screws 815a and 815b. The wall portion 823b is a member having an approximate cylindrical shape that is integrally provided with the bottom surface 823a to erect upward from the peripheral edge portion of the bottom surface 823a. In the present embodiment, the engagement member 823 is formed from resin. The rotation shaft 822 of the gear 821 penetrates the fixed plate portion 811a and the bottom surface 823a to a space inside the wall portion 823b. Therefore, the wall portion 823b is fixed around the rotation shaft 822.

In addition, as illustrated in FIGS. 16A and 17A, the engagement member 823 includes second engagement portions 823ba and 823bb capable of engaging with first engagement portions 825ab and 825bb that will be described later. The second engagement portions 823ba and 823bb are formed at positions in point symmetry with each other with respect to the rotation shaft 822 and are each formed by recessing part of the inner peripheral surface of the wall portion 823b of the engagement member 823 outward in a radial direction. Specifically, the second engagement portion 823ba includes an inclined surface portion 823ba1 where part of the inner peripheral surface of the wall portion 823b is gradually inclined outward in the radial direction with respect to the rotational direction (clockwise direction of FIGS. 16A and 16B) of a rotary metal plate 824 that will be described later, and an engagement surface 823ba2 continuous with the downstream end of the inclined surface portion 823ba1 and extending inward in the radial direction from this downstream end. Similarly, the second engagement portion 823bb includes an inclined surface portion 823bb1 and an engagement surface 823bb2.

The rotary metal plate 824 rotates in accordance with the rotation of the rotation shaft 822. In the present embodiment, the rotary metal plate 824 is disposed on the inner side of the wall portion 823b constituting the engagement member 823, is fixed to the rotation shaft 822, and integrally rotates with the rotation shaft 822. A pair of engagement metal plates 825a and 825b are provided on the inner side of the wall portion 823b so as to be pivotable with respect to the rotary metal plate 824. Specifically, the pair of engagement metal plates 825a and 825b are respectively supported by rotation shafts 826a and 826b so as to be rotatable with respect to the rotary metal plate 824. The pair of engagement metal plates 825a and 825b are formed to be in point symmetry with each other with respect to the rotation shaft 822. In addition, since the pair of engagement metal plates 825a and 825b are supported by the rotary metal plate 824 via the rotation shafts 826a and 826b, the pair of engagement metal plates 825a and 825b rotate about the rotational axis of the rotation shaft 822 together with the rotary metal plate 824 and the rotation shaft 822.

In addition, the pair of engagement metal plates 825a and 825b are respectively provided with spring hooking portions 825aa and 825ba and first engagement portions 825ab and 825bb. The spring hooking portions 825aa and 825ba are portions on which two end portions of a spring 827 that will be described later are hooked. The first engagement portions 825ab and 825bb are formed at a downstream end portion in the rotational direction (clockwise direction of FIGS. 16A and 16B) of the rotary metal plate 824 at positions below the spring hooking portions 825aa and 825ba. Further, as will be described later, the first engagement portions 825ab and 825bb are capable of engaging with the second engagement portions 823ba and 823bb of the engagement member 823.

The rotation shafts 826a and 826b are fixed to the rotary metal plate 824 so as to be approximately parallel to the rotation shaft 822, and respectively pivotably support the pair of engagement metal plates 825a and 825b. Therefore, the pair of engagement metal plates 825a and 825b respectively pivot about the rotation shafts 826a and 826b in a direction in which the first engagement portions 825ab and 825bb move closer to and away from the inner peripheral surface of the wall portion 823b of the engagement member 823.

Two end portions of the spring 827 serving as an urging portion are respectively hooked on the spring hooking portion 825aa of the engagement metal plate 825a and the spring hooking portion 825ba of the engagement metal plate 825b. That is, the spring 827 extends from one to the other of the two engagement metal plates 825a and 825b respectively including the first engagement portions 825ab and 825bb. Further, the spring 827 urges the two first engagement portions 825ab and 825bb in a direction to move closer to each other. That is, the spring 827 urges the first engagement portions 825ab and 825bb in a direction away from the inner peripheral surface of the wall portion 823b. FIGS. 16A and 17A each illustrate a state in which the first engagement portions 825ab and 825bb are separated from the inner peripheral surface of the wall portion 823b by the urging force of the spring 827.

Here, the rotational speed of the rotation shaft 822 rotating via the gear train including the rack 801 and the gear 802 in the case where the movement speed of the saddle portion B2 in the insertion direction will be referred to as a predetermined rotational speed. In this case, the first engagement portions 825ab and 825bb spread outward in the radial direction in the case where the rotational speed of the rotation shaft 822 is equal to or higher than the predetermined rotational speed. When the first engagement portions 825ab and 825bb are spread outward in the radial direction by the centrifugal force, the second engagement portions 823ba and 823bb engage with the first engagement portions 825ab and 825bb to stop the rotation of the rotation shaft 822.

Specifically, in the case where the saddle portion B2 is returned to the attached position at a high speed, the abutting portion 580 fixed to the saddle portion B2 abuts the abutting surface 801a of the rack 801, and thus the rack 801 slides from the front side toward the rear side at the same speed as the saddle portion B2. Further, the gear 802 rotates in accordance with the slide movement of the rack 801. This rotation is transmitted to the gear 821 of the centrifugal brake unit 820 via the gears 802, 806, and 808, and thus the gear 821 rotates at a speed accelerated from the rotational speed of the gear 802 corresponding to the slide movement speed of the rack 801.

Since the gear 821 is fixed to the rotation shaft 822, the rotary metal plate 824 fixed to the rotation shaft 822 rotates in accordance with the rotation of the gear 821. The rotational speed of the rotary metal plate 824 is a speed corresponding to the speed at which the saddle portion B2 is returned to the attached position. That is, in the case where the saddle portion B2 is returned at a high speed, the rotary metal plate 824 rotates at a high speed, and in the case where the saddle portion B2 is returned at a low speed, the rotary metal plate 824 rotates at a low speed. Further, in the case where the movement speed of the rack 801 in the B direction is low, the pair of engagement metal plates 825a and 825b are closed by being urged by the spring 827, and continue rotating inside the engagement member 823.

In addition, in the engagement metal plates 825a and 825b, in the case where the rotational speed of the rotation shaft 822 is higher than the predetermined rotational speed (that is, in the case where the movement speed of the rack 801 in the B direction is high), the first engagement portions 825ab and 825bb of the engagement metal plates 825a and 825b open in a direction away from each other by the centrifugal force against the urging force of the spring 827. When opened, the first engagement portions 825ab and 825bb engage with the second engagement portions 823ba and 823bb of the engagement member 823. Further, as a result of the first engagement portions 825ab and 825bb engaging with the second engagement portions 823ba and 823bb, a locked state is taken, and the rotation of the rotary metal plate 824 with respect to the engagement member 823 is temporarily stopped. That is, the centrifugal brake unit 820 acts. Then, in accordance with the stoppage of the rotation of the rotary metal plate 824, rotation of the rotation shaft 822 and the gears 821, 808, 806, and 804 also stops.

In this state, the saddle portion B2 is still moving in the direction to return to the attached position, and therefore the gear 802 continues rotating in accordance with the movement of the rack 801, and the gear unit 810 continues input of rotational force in an arrow direction illustrated in FIG. 15. At this time, a load is applied to the gear 802 of the gear unit 810 by the rotational load applied by the transmission member 805 rotating in a different direction, and thus a load is applied to the slide movement of the rack 801. That is, in the case where the centrifugal brake unit 820 acts and the rotary metal plate 824 is locked in a state in which the rack 801 is still moving in the B direction, the rotation of the rotation shaft 822 and the gears 821, 808, 806, and 804 is stopped as described above. Since the transmission member 805 is present between the gear 804 and the rotation shaft 803, the rotation shaft 803 rotates while receiving a load from the load application portion 805a (FIG. 15) of the transmission member 805. Further, the predetermined torque of the load application portion 805a is transmitted to the saddle portion B2 via the rotation shaft 803, the gear 802, and the rack 801. As a result of this, in the case where the saddle portion B2 is accommodated at a speed equal to or higher than the predetermined speed, the movement speed of the saddle portion B2 is reduced. That is, the movement speed of the saddle portion B2 to the attached position is reduced. In addition, as a result of this, the impact imposed on the centrifugal brake unit 820 when the centrifugal brake unit 820 acts can be absorbed by allowing the movement of the saddle portion B2 to the attached position in a state in which the centrifugal brake unit 820 is acting. Therefore, occurrence of a trouble in the centrifugal brake unit 820 can be suppressed.

In addition, in the present embodiment, in the case where the saddle portion B2 is inserted in a direction from the drawn-out position toward the attached position at a speed equal to or higher than the predetermined speed, the centrifugal brake unit 820 continues the acting state until the saddle portion B2 is positioned at the attached position. As described above, also in a state in which the centrifugal brake unit 820 is acting, the rotation shaft 803 rotates while receiving the predetermined torque from the load application portion 805a. Therefore, the rotation of the rotation shaft 803 is transmitted to the gear 804 via the load application portion 805a of the transmission member 805. Further, this rotation is transmitted to the rotation shaft 822 via the gears 806, 808, and 821. At this time, as illustrated in FIG. 16B, transmission of rotation in the clockwise direction to the rotary metal plate 824 is continued in the locked state in which the first engagement portions 825ab and 825bb of the engagement metal plates 825a and 825b are engaged with the engagement surfaces 823ba2 and 823bb2 of the second engagement portions 823ba and 823bb. As a result of this, in a state in which the movement of the saddle portion B2 in a direction from the drawn-out position toward the attached position is continued, the locked state in which the first engagement portions 825ab and 825bb of the engagement metal plates 825a and 825b are engaged with the second engagement portions 823ba and 823bb is maintained.

Then, when the saddle portion B2 has reached the attached position, the movement of the rack 801 in the arrow B direction is stopped, and the rotation of the rotation shaft 803 is stopped, the rotational load is no longer transmitted to the rotation shaft 822. As a result of this, the rotational load on the first engagement portions 825ab and 825bb applied in a direction to engage with the engagement surfaces 823ba2 and 823bb2 is eliminated, and the engagement metal plates 825a and 825b are urged in a direction to move closer to each other by the urging force of the spring 827. As a result of this, the engagement between the first engagement portions 825ab and 825bb and the second engagement portions 823ba and 823bb is released and thus the lock is released, and the centrifugal brake unit 820 stops acting. That is, when the saddle portion B2 is positioned at the attached position and the movement of the saddle portion B2 in the insertion direction is stopped, the slide movement of the rack 801 and the rotation of the gear 802 are stopped, the rotation of the rotary metal plate 824 is stopped. As a result of this, when the rotational load on the rotary metal plate 824 is no longer applied, the first engagement portions 825ab and 825bb are moved in a closing direction, that is, in a direction to move closer to each other by the urging force of the spring 827, and thus the engagement between the first engagement portions 825ab and 825bb and the second engagement portions 823ba and 823bb is released. As a result of this, the brake of the centrifugal brake unit 820 stops acting.

That is, in the present embodiment, in the case where the rotational speed of the rotation shaft 822 is equal to or higher than the predetermined rotational speed, the first engagement portions 825ab and 825bb spread outward in the radial direction by the centrifugal force against the urging force of the spring 827 and engage with the second engagement portions 823ba and 823bb to take the locked state. In contrast, when the insertion operation of the saddle portion B2 is finished and the movement is stopped, the first engagement portions 825ab and 825bb move inward in the radial direction by the urging force of the spring 827, and the engagement with the second engagement portions 823ba and 823bb is released. Then, as a result of the engagement between the first engagement portions 825ab and 825bb and the second engagement portions 823ba and 823bb being released, the lock of the centrifugal brake unit 820 is released, and the brake stops acting. In the configuration described above, a state in which the first engagement portions 825ab and 825bb are engaged with the second engagement portions 823ba and 823bb and the rotation is locked is the locked state, in which the brake of the centrifugal brake unit 820 is acting. Further, a state in which the engagement between the first engagement portions 825ab and 825bb and the second engagement portions 823ba and 823bb is released and the rotation is possible is a lock-released state, in which the brake of the centrifugal brake unit 820 is not acting.

In the present embodiment, a configuration in which the rotational speed of the rotation shaft 822 reaches 1080 rpm and the first engagement portions 825ab and 825bb open in a direction away from each other against the urging force of the spring 827 when, for example, the movement speed of the saddle portion B2 toward the attached position is 1200 mm/s or higher, is employed. That is, the centrifugal brake unit 820 is configured to act when the saddle portion B2 moves toward the attached position at a speed of 1200 mm/s or higher. In the present embodiment, the gear ratio between the gears 802 and 821 is set to 1:9 such that the centrifugal brake unit 820 acts in these conditions.

To be noted, the centrifugal brake unit 820 may be configured to act when the saddle portion B2 is inserted at a speed even higher than the movement speed described above. For example, a condition in which the centrifugal brake unit 820 acts when the movement speed of the saddle portion B2 is higher than 1500 mm/s may be employed. To cause the centrifugal brake to act when the movement speed of the saddle portion B2 is higher by using the configuration described above, the urging force of the spring 827 may be increased, the weight of the first engagement portions 825ab and 825bb may be increased, or the reduction ratio of the gear unit may be changed.

As described above, in the case where the movement speed of the saddle portion B2 in the insertion direction is equal to or higher than the predetermined speed, the braking device 800 of the present embodiment reduces the movement speed of the saddle portion B2 in the insertion direction, and then allows the movement of the saddle portion B2 at a speed lower than the predetermined speed in the insertion direction. That is, in the case where the saddle portion B2 is returned to the attached position at a high speed, the movement speed of the saddle portion B2 is reduced by the braking device 800.

As described above, in the present embodiment, even when the saddle portion B2 is inserted into the housing 27 at a high speed, the movement of the saddle portion B2 in the insertion direction is regulated by the braking device 800, and thus an impact is not imposed on the body frame 500 of the housing 27. Therefore, occurrence of a trouble of the apparatus such as deformation of the body frame 500 or malfunction of other units can be suppressed. In addition, occurrence of a situation in which the saddle portion B2 collides with the body frame 500 at a high speed and thus the relative positions of the image forming apparatus A and the sheet processing apparatus B are displaced to cause skew of the sheet can be also suppressed. In addition, in a configuration in which the centrifugal brake unit 820 acts when the saddle portion B2 is inserted at a high speed, a situation in which an impact is imposed on the centrifugal brake unit 820 itself can be suppressed.

To be noted, a configuration in which a spring is disposed on the rear side of the body frame 500 to relieve the impact even when the saddle portion B2 is returned to the attached position at a high speed can be also considered. To be noted, there is a possibility that the saddle portion B2 pops out forward at a high speed when the saddle portion B2 hits the spring. In contrast, in the present embodiment, since the braking device 800 is provided to regulate the movement of the saddle portion B2 in the case where the saddle portion B2 is inserted at a high speed, the saddle portion B2 does not pop out to the front side of the apparatus at a high speed.

### Another Example

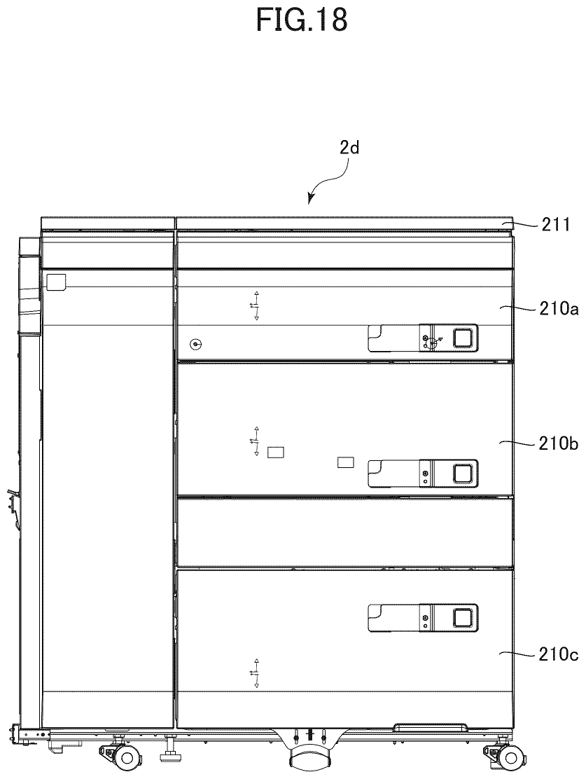

Although a configuration in which the braking device 800 described above is provided in the sheet processing apparatus B has been described above, the element provided with the braking device 800 described above does not have to be the sheet processing apparatus B. For example, the braking device 800 may be provided for cassettes 210a, 210b, and 210c of a sheet accommodating apparatus 2d as illustrated in FIG. 18. The sheet accommodating apparatus 2d is, for example, configured as illustrated in FIG. 1.

The sheet accommodating apparatus 2d includes a plurality of cassettes 210a to 210c that can be drawn out. The plurality of cassettes 210a to 210c serving as accommodation units are disposed so as to be capable of being drawn out from the housing 211 serving as a casing and inserted to an attached position in the housing 211, and accommodate sheets. These cassettes 210a to 210c each accommodate 1,500 to 2,000 sheets in some cases. In the case where more sheets are accommodated in the cassette, the cassette becomes heavier, and thus it becomes more likely that the cassette moves at a high speed when returning the cassette from the position drawn out from the apparatus to the attached position. Therefore, by providing the braking device 800 described above, a situation in which the cassettes 210a to 210c are returned into the sheet accommodating apparatus 2d at a high speed can be suppressed similarly to the case where the braking device 800 is provided in the sheet processing apparatus B.

As a result of this, deformation of a support frame of the housing 211 of the sheet accommodating apparatus 2d and malfunction of each unit can be suppressed. In addition, deformation of the coupling portion between the image forming apparatus A and the sheet accommodating apparatus 2d can be suppressed. As a result of this, skew of the sheet conveyed from the sheet accommodating apparatus 2d to the image forming apparatus A and the like caused by deviation of the relative positions of the image forming apparatus A and the sheet accommodating apparatus 2d can be suppressed. In addition, in a configuration in which the centrifugal brake unit 820 acts when any of the cassettes 210a to 210c is inserted at a high speed, the impact imposed on the centrifugal brake unit 820 itself can be suppressed.

### Other Embodiments

Although the braking device 800 is provided on the right lower stay 500b of the body frame 500 near the rail on the lower right side in the embodiment described above, the braking device 800 may be provided near the rail on the lower left side. In addition, although only one braking device 800 is provided in the embodiment described above, a plurality of braking device 800 may be provided. For example, the braking devices 800 may be provided at positions that are in symmetry in the left-right direction. Further, the numbers of the first engagement portions 825ab and 825bb and the second engagement portions 823ba and 823bb may be each one or a plural number as long as the speed of the unit moving at a high speed can be reduced. It is more preferable that the first engagement portion and the second engagement portion are each provided in a plural number (two or more) because the unit can be stopped more quickly. To be noted, in the case where the first engagement portion and the second engagement portion are each provided in a plural number, it is preferable that the engagement portions are provided at positions in point symmetry with each other with respect to the rotation shaft 822.

In addition, although the wall portion 823b of the engagement member 823 on which the second engagement portions 823ba and 823bb are formed is formed in an approximate cylindrical shape in the embodiment described above, the member on which the second engagement portions 823ba and 823bb are formed does not have to be in a cylindrical shape as long as the rotation of the engagement metal plates 825a and 825b is not interrupted during normal rotation and the first engagement portions 825ab and 825bb of the engagement metal plates 825a and 825b can engage with the second engagement portions 823ba and 823bb of the wall portion 823b during fast rotation. For example, a plurality of plate-shaped members may be arranged in circle at a predetermined pitch.

In addition, although the rack 801 is provided on the body frame 500 side in the embodiment described above, the rack 801 may be provided on the saddle portion B2 side. To be noted, in the case where the rack 801 is provided on the saddle portion B2 side, the spring 830 and the like that is needed in the case of providing the rack 801 on the body frame 500 side is no longer needed, but the rack 801 needs to be configured to be always engaged with the gear 802 of the gear unit 810 provided on the body frame 500. Therefore, in this case, the length of the rack 801 in the front-rear direction is larger than in the embodiment described above. In the embodiment described above, the rack 801 is provided on the body frame 500 side, and therefore the size in the F-B direction can be reduced as compared with the case where the rack 801 is provided on the saddle portion B2 side. In addition, the workability at the time of assembly of the apparatus can be improved.

In the embodiment described above, a case where the processing unit is a saddle portion B2 that performs a half-folding process, a saddle binding process, and a square back process as a predetermined process has been described. However, the processing unit is not limited to this, and may be a unit that performs one of these processes or a unit that performs a plurality of processes. In addition, the predetermined process is not limited to these processes, and may be an end binding process to be performed on an end portion of a sheet bundle, or a punching process of punching a hole in the sheet bundle. That is, it suffices as long as the predetermined process includes one or a plurality of processes among various processes that are conventionally known to be performed on a sheet or a sheet bundle, such as the half-folding process, the saddle binding process, the square back process, the end binding process, and the punching process.

Further, although a roller pair has been described as an example of a conveyance portion that conveys the sheet in the sheet processing apparatus B in the embodiment described above, the sheet may be conveyed by a belt. Specifically, any of a configuration in which the sheet is nipped and conveyed by a pair of belts, and a configuration in which the sheet is nipped and conveyed by a belt and a roller may be employed, and the configuration for conveyance may be changed in accordance with the position and path for conveyance of the sheet. For example, the sheet may be conveyed by a pair of rollers at a certain position and by a pair of belts at another position.

In addition, although the image forming system 1000 in which the sheet processing apparatus B is directly connected to the image forming apparatus A has been described in the embodiment described above, a different system configuration may be employed. For example, another processing apparatus, a conveyance apparatus, or the like may be connected between the image forming apparatus A and the sheet processing apparatus B. In addition, although the image forming apparatus A that forms a monochromatic image by using toner has been described as an example in the embodiment described above, an image forming apparatus that forms a color image by using toner may be used, or an image forming apparatus that forms an image on a sheet by using ink may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-222471, filed on Dec. 28, 2023 and Japanese Patent Application No. 2024-180650, filed on Oct. 16, 2024, which are hereby incorporated by reference herein in their entirety.

What is claimed is:

1. A sheet processing apparatus comprising:
a processing unit movable to a drawn-out position and an accommodated position and configured to perform a predetermined process on a sheet, the drawn-out position being a position where the processing unit is drawn out from the sheet processing apparatus, the accommodated position being a position where the processing unit is accommodated in the sheet processing apparatus;
a braking mechanism configured to act to brake the processing unit in a case where the processing unit is inserted in a direction from the drawn-out position toward the accommodated position at a speed equal to or higher than a predetermined speed; and
a damper mechanism configured to absorb an impact on the braking mechanism in a case where the braking mechanism act, by applying a load to the processing unit moving in the direction from the drawn-out position toward the accommodated position.

2. The sheet processing apparatus according to claim 1, wherein, in the case where the processing unit is inserted in the direction from the drawn-out position toward the accommodated position at the speed equal to or higher than the predetermined speed, the braking mechanism continues an acting state until the processing unit is positioned at the accommodated position.

3. The sheet processing apparatus according to claim 1,
wherein the damper mechanism includes
a first gear configured to rotate by receiving input of a driving force by movement of the processing unit in the direction from the drawn-out position toward the accommodated position, and
a second gear configured to rotate in accordance with rotation of the first gear,
wherein the braking mechanism allows rotation of the second gear in a case where the processing unit is inserted in the direction from the drawn-out position toward the accommodated position at a speed lower than the predetermined speed, and stop the rotation of the second gear in the case where the processing unit is inserted in the direction from the drawn-out position toward the accommodated position at the speed equal to or higher than the predetermined speed, and
wherein, in a case where the rotation of the second gear is stopped, the damper mechanism reduces a movement speed of the processing unit by applying a load to the first gear.

4. The sheet processing apparatus according to claim 3, further comprising:
a rack configured to move in accordance with movement of the processing unit in the direction from the drawn-out position toward the accommodated position, by abutting the processing unit moving in the direction from the drawn-out position toward the accommodated position,
wherein the rack inputs the driving force to the first gear by engaging with the first gear.

5. The sheet processing apparatus according to claim 3,
wherein the braking mechanism includes
a rotation shaft configured to rotate by receiving the rotation of the second gear transmitted thereto,
a first engagement portion configured to rotate together with the rotation shaft and spread outward in a radial direction by centrifugal force in a case where a rotational speed of the rotation shaft is equal to or higher than a predetermined rotational speed, the predetermined rotational speed being the rotational speed of the rotation shaft rotating via the first gear and the second gear in a case where the movement speed of the processing unit in the direction from the drawn-out position toward the accommodated position is equal to the predetermined speed, and
a second engagement portion configured to engage with the first engagement portion to stop rotation of the rotation shaft in a case where the first engagement portion has spread outward in the radial direction by the centrifugal force.

6. The sheet processing apparatus according to claim 5,
wherein the braking mechanism includes an urging portion configured to urge the first engagement portion inward in the radial direction, and
wherein the first engagement portion engages with the second engagement portion by spreading outward in the radial direction by the centrifugal force against the urging force of the urging portion in a case where the rotational speed of the rotation shaft is equal to or higher than the predetermined rotational speed.

7. The sheet processing apparatus according to claim 6,
wherein the first engagement portion includes a first engagement metal plate and a second engagement metal plate, and
wherein the urging portion is provided to extend from the first engagement metal plate to the second engagement metal plate and urges the first engagement metal plate and the second engagement metal plate in a direction to move closer to each other.

8. The sheet processing apparatus according to claim 6,
wherein the braking mechanism includes a cylindrical member fixed around the rotation shaft,
wherein the first engagement portion is disposed on an inside of the cylindrical member, and
wherein the second engagement portion is formed on an inner peripheral surface of the cylindrical member.

9. The sheet processing apparatus according to claim 5, wherein the damper mechanism includes a one-direction rotation transmission portion configured to transmit rotation to the rotation shaft in a case where the processing unit moves in the direction from the drawn-out position toward the accommodated position, and does not transmit rotation from the rotation shaft in a case where the processing unit moves in a draw-out direction.

10. The sheet processing apparatus according to claim 1,
wherein the processing unit includes
a conveyance portion configured to convey a sheet bundle subjected to a half-folding process or the sheet bundle subjected to a saddle binding process and the half-folding process such that a spine of the sheet bundle is positioned downstream of a fore edge of the sheet bundle in a conveyance direction in which the conveyance portion conveys the sheet bundle, and
a square back processing portion including a pair of nipping units and a pressing roller and configured to press, by the pressing roller, the spine of the sheet bundle nipped by the pair of nipping units such that the spine of the sheet bundle projects downstream with respect to the pair of nipping units in the conveyance direction, the pair of nipping units being configured to nip the sheet bundle and release the nipping of the sheet bundle by relatively moving with respect to the sheet bundle conveyed by the conveyance portion, the pressing roller being configured to press the spine of the sheet bundle nipped by the pair of nipping units toward the pair of nipping units, and
wherein the predetermined process includes the square back process.

11. An image forming system comprising:
an image forming unit including an image forming portion configured to form an image on a sheet; and
a sheet processing apparatus configured to perform a predetermined process on the sheet on which the image has been formed by the image forming portion,
wherein the sheet processing apparatus includes
a processing unit movable to a drawn-out position and an accommodated position and configured to perform the predetermined process on the sheet, the drawn-out position being a position where the processing unit is drawn out from the sheet processing apparatus, the accommodated position being a position where the processing unit is accommodated in the sheet processing apparatus,
a braking mechanism configured to act to brake the processing unit in a case where the processing unit is inserted in a direction from the drawn-out position toward the accommodated position at a speed equal to or higher than a predetermined speed, and
a damper mechanism configured to absorb an impact on the braking mechanism in a case where the braking mechanism act, by applying a load to the processing unit moving in the direction from the drawn-out position toward the accommodated position.

12. A sheet accommodating apparatus comprising:
an accommodation unit movable to a drawn-out position and an accommodated position and configured to accommodate a sheet, the drawn-out position being a position where the accommodation unit is drawn out from the sheet accommodating apparatus, the accommodated position being a position where the accommodation unit is accommodated in the sheet accommodating apparatus;
a braking mechanism configured to act to brake the accommodation unit in a case where the accommodation unit is inserted in a direction from the drawn-out position toward the accommodated position at a speed equal to or higher than a predetermined speed; and
a damper mechanism configured to absorb an impact on the braking mechanism in a case where the braking mechanism act, by applying a load to the accommodation unit moving in the direction from the drawn-out position toward the accommodated position.

13. The sheet accommodating apparatus according to claim 12, wherein, in the case where the accommodation unit is inserted in the direction from the drawn-out position toward the accommodated position at the speed equal to or higher than the predetermined speed, the braking mechanism continues an acting state until the accommodation unit is positioned at the accommodated position.

14. The sheet accommodating apparatus according to claim 12,
wherein the damper mechanism includes
a first gear configured to rotate by receiving input of a driving force by movement of the accommodation unit in the direction from the drawn-out position toward the accommodated position, and
a second gear configured to rotate in accordance with rotation of the first gear,
wherein the braking mechanism allows rotation of the second gear in a case where the accommodation unit is inserted in the direction from the drawn-out position toward the accommodated position at a speed lower than the predetermined speed, and stop the rotation of the second gear in the case where the accommodation unit is inserted in the direction from the drawn-out position toward the accommodated position at the speed equal to or higher than the predetermined speed, and
wherein, in a case where the rotation of the second gear is stopped, the damper mechanism reduces a movement speed of the accommodation unit by applying a load to the first gear.

15. The sheet accommodating apparatus according to claim 14, further comprising:
a rack configured to move in accordance with movement of the accommodation unit in the direction from the drawn-out position toward the accommodated position, by abutting the accommodation unit moving in the direction from the drawn-out position toward the accommodated position,
wherein the rack inputs the driving force to the first gear by engaging with the first gear.

16. The sheet accommodating apparatus according to claim 14,
wherein the braking mechanism includes
a rotation shaft configured to rotate by receiving the rotation of the second gear transmitted thereto,
a first engagement portion configured to rotate together with the rotation shaft and spread outward in a radial direction by centrifugal force in a case where a rotational speed of the rotation shaft is equal to or higher than a predetermined rotational speed, the predetermined rotational speed being the rotational speed of the rotation shaft rotating via the first gear and the second gear in a case where the movement speed of the accommodation unit in the direction from the drawn-out position toward the accommodated position is equal to the predetermined speed, and
a second engagement portion configured to engage with the first engagement portion to stop rotation of the rotation shaft in a case where the first engagement portion has spread outward in the radial direction by the centrifugal force.

17. The sheet accommodating apparatus according to claim 16,
wherein the braking mechanism includes an urging portion configured to urge the first engagement portion inward in the radial direction, and
wherein the first engagement portion engages with the second engagement portion by spreading outward in the radial direction by the centrifugal force against the urging force of the urging portion in a case where the rotational speed of the rotation shaft is equal to or higher than the predetermined rotational speed.

18. The sheet accommodating apparatus according to claim 17,
wherein the first engagement portion includes a first engagement metal plate and a second engagement metal plate, and
wherein the urging portion is provided to extend from the first engagement metal plate to the second engagement metal plate and urges the first engagement metal plate and the second engagement metal plate in a direction to move closer to each other.

19. The sheet accommodating apparatus according to claim 17,
wherein the braking mechanism includes a cylindrical member fixed around the rotation shaft,
wherein the first engagement portion is disposed on an inside of the cylindrical member, and
wherein the second engagement portion is formed on an inner peripheral surface of the cylindrical member.

20. The sheet accommodating apparatus according to claim 16, wherein the damper mechanism includes a one-direction rotation transmission portion configured to transmit rotation to the rotation shaft in a case where the accommodation unit moves in the direction from the drawn-out position toward the accommodated position, and does not transmit rotation from the rotation shaft in a case where the accommodation unit moves in a draw-out direction.

21. An image forming system comprising:
a sheet accommodating apparatus configured to accommodate a sheet; and
an image forming unit including an image forming portion configured to form an image on the sheet fed from the sheet accommodating apparatus,
wherein the sheet accommodating apparatus includes
an accommodation unit movable to a drawn-out position and an accommodated position and configured to accommodate the sheet, the drawn-out position being a position where the accommodation unit is drawn out from the sheet accommodating apparatus, the accommodated position being a position where the accommodation unit is accommodated in the sheet accommodating apparatus,
a braking mechanism configured to act to brake the accommodation unit in a case where the accommodation unit is inserted in a direction from the drawn-out position toward the accommodated position at a speed equal to or higher than a predetermined speed, and
a damper mechanism configured to absorb an impact on the braking mechanism in a case where the braking mechanism act, by applying a load to the accommodation unit moving in the direction from the drawn-out position toward the accommodated position.
